(19) United States
(12) Patent Application Publication
(10) Pub. No.: US 2005/0166139 A1
(43) Pub. Date: Jul. 28, 2005

(54) System and method for managing legal documents

(76) Inventors: John Scott Pittman, Dallas, TX (US); William Caspar Campaigne, San Antonio, TX (US)

Correspondence Address: Raffi Gostanian, Jr.;Jackson Walker L.L.P., Suite 600, 2435 North Central Expressway, Richardson, TX, 75080, US

(21) Appl. No.: 10/865,150

(22) Filed: Jun. 10, 2004

Related U.S. Application Data
(60) Provisional application No. 60/477,181, filed on Jun. 10, 2003.

(51) Int. Cl. G06F 17/00

(52) U.S. Cl. 715/511; 715/513; 707/7

(57) ABSTRACT

The present invention discloses a method, system, and computer readable medium for managing documents that comprises associating a first document in a first category with a second document in a second category, and grouping the documents.

### CROSS REFERENCE TO RELATED APPLICATION

The present application is related to and claims the benefit of U.S. Provisional Patent Application No. 60/477,181 filed Jun. 10, 2003, entitled LITIGATION DOCUMENT MANAGEMENT SYSTEM. Applicants hereby claim the benefit of this Provisional Patent Application under 35 U.S.C. Section 119(e), the entire contents of which are incorporated by reference herein.

### FIELD OF THE INVENTION

The present invention relates to managing documents and, more particularly, to a system and method for managing legal documents.

### BACKGROUND OF THE INVENTION

Document management is a critical process for nearly every organization. This is especially true for law firms or other organizations that originate, handle, and distribute a large number of legal and related documents. The effective management, organization and utilization of such documents in an electronic format is of paramount importance.

Some conventional electronic systems and methods for managing, organizing, and utilizing legal documents focus solely on certain areas, such as discovery, and not on other areas that may be considered critical. Other conventional systems and methods are not scalable or adaptable, do not allow a user to search for or compile a document production set, to batch print such a set or other documents, or to easily transfer information from one document to another. Further, other conventional systems and methods rely on a second or a third system and method to collectively provide document management services. Still other systems and methods can only perform basic full-text searches and not proximity or fuzzy searches.

Other problems associated with conventional systems and methods for managing, organizing, and utilizing legal documents include documents that are broken down into distinct and separate groups. For example, depositions, pleadings, exhibits and correspondence may all be contained in or associated with separate categories. The problem with this scenario is that one may never know if a particular document is associated with another, or which documents may be associated with any given witness, for example. Further, related documents may exist within a plurality of categories. It is therefore desirable for the present invention to overcome the limitations and problems described above that are involved with document management and utilization.

### SUMMARY OF THE INVENTION

The present invention achieves technical advantages as a system and method for managing legal documents by providing users with tools by which to effectively and securely access and organize the plethora of documents that exist in the legal arena in order to effectively prepare for and participate in a legal event such as litigation.

In one embodiment, a method for managing documents comprises associating a first document in a first category with a second document in a second category, and grouping the documents.

In another embodiment, a computer readable medium comprises instructions for associating a first document in a first category with a second document in a second category, wherein the first document and the second document have at least one related item, and wherein the categories are separate, grouping the documents, and creating a binder including the grouped documents.

In a further embodiment, a method for entering data relating to a document comprises dynamically generating a layout of fields for data entry, based on a type of document chosen and on a specific template that is selected; retrieving a pre-configured template containing a list of relevant fields, and directions for writing their contents to a database, wherein the relevant fields are related to the fields laid out for data entry; and writing the contents of the relevant fields to the database.

In yet another embodiment, a system for document management comprises means for generating a formatted list by consulting a template, and means for displaying sets of metadata in the formatted list, wherein the formatted list is adapted to display rows and columns of information.

In yet a further embodiment, a system for document management comprises a client adapted to generate a formatted list by consulting a template, and a server adapted to display sets of metadata in the formatted list, wherein the client is operably coupled to the server.

### BRIEF DESCRIPTION OF THE DRAWINGS

FIG. 1 depicts a main page and menu tree of a graphical user interface (GUI) in accordance with an exemplary embodiment of the present invention;

FIG. 2 depicts a witness folder of the menu tree and an expanded view of the witness subfolders of a GUI in accordance with an exemplary embodiment of the present invention;

FIG. 3 depicts a plaintiff subfolder of the witness folder comprising coded metadata header of a GUI in accordance with an exemplary embodiment of the present invention;

FIG. 4 depicts an expert subfolder of the witness folder comprising coded metadata header of a GUI in accordance with an exemplary embodiment of the present invention;

FIG. 5 depicts an all subfolder of the witness folder comprising coded metadata header of a GUI in accordance with an exemplary embodiment of the present invention;

FIG. 6 depicts a party folder of the menu tree and an expanded with main subfolders of a GUI in accordance with an exemplary embodiment of the present invention;

FIG. 7 depicts a plaintiff subfolder of the party folder with expanded subfolders of a GUI in accordance with an exemplary embodiment of the present invention;

FIG. 8 depicts a plaintiff subfolder of the party folder with expanded subfolder of a GUI in accordance with an exemplary embodiment of the present invention;

FIG. 9 depicts a subfolder subfolder of a plaintiff subfolder of the party folder with employee coded metadata header of a GUI in accordance with an exemplary embodiment of the present invention;

FIG. 10 depicts a subfolder subfolder of a plaintiff subfolder of the party folder with deposition coded metadata header of a GUI in accordance with an exemplary embodiment of the present invention;

FIG. 11 depicts a subfolder subfolder of a plaintiff subfolder of the party folder with a trial exhibit coded metadata header of a GUI in accordance with an exemplary embodiment of the present invention;

FIG. 12 depicts a defendant subfolder of the party folder of a GUI in accordance with an exemplary embodiment of the present invention;

FIG. 13 depicts a subfolder subfolder of a defendant subfolder of the party folder of a GUI in accordance with an exemplary embodiment of the present invention;

FIG. 14 depicts a third party subfolder of a defendant subfolder of the party folder with expanded subfolders of a GUI in accordance with an exemplary embodiment of the present invention;

FIG. 15 depicts a defendant folder with expanded subfolders of a GUI in accordance with an exemplary embodiment of the present invention;

FIG. 16 depicts a type subfolder of the menu tree folder comprising subfolders of a GUI in accordance with an exemplary embodiment of the present invention;

FIG. 17 depicts a deposition subfolder of the type folder comprising coded metadata header of a GUI in accordance with an exemplary embodiment of the present invention;

FIG. 18 depicts an exhibit subfolder of the type folder expanded with subfolders of a GUI in accordance with an exemplary embodiment of the present invention;

FIG. 19 depicts a trial subfolder of an exhibit subfolder of the type folder comprising coded metadata header of a GUI in accordance with an exemplary embodiment of the present invention;

FIG. 20 depicts a transcript subfolder of the type folder expanded with subfolders of a GUI in accordance with an exemplary embodiment of the present invention;

FIG. 21 depicts an event folder of the menu tree and expanded folders and subfolders of a GUI in accordance with an exemplary embodiment of the present invention;

FIG. 22 depicts a plaintiff subfolder of a trial exhibit subfolder of the trial subfolder of the event folder comprising coded metadata header of a GUI in accordance with an exemplary embodiment of the present invention;

FIG. 23 depicts an all subfolder of a trial exhibit subfolder of a trial subfolder of the event folder comprising coded metadata header of a GUI in accordance with an exemplary embodiment of the present invention;

FIG. 24 depicts a both subfolder of a trial subfolder of the event folder comprising coded metadata header of a GUI in accordance with an exemplary embodiment of the present invention;

FIG. 25 depicts a deposition folder expanded with subfolders of the menu tree expanded with subfolders and a plaintiff subfolder of the deposition folder comprising coded metadata header of a GUI in accordance with an exemplary embodiment of the present invention;

FIG. 26 depicts an expert subfolder of the deposition folder comprising coded metadata header of a GUI in accordance with an exemplary embodiment of the present invention;

FIG. 27 depicts an all subfolder of a deposition folder comprising coded metadata header of a GUI in accordance with an exemplary embodiment of the present invention;

FIG. 28 depicts a case document folder of the menu tree and expanded with subfolders of a GUI in accordance with an exemplary embodiment of the present invention;

FIG. 29 depicts a binder folder of the menu tree and expanded with subfolders and my binders subfolder of the binders folder comprising coded metadata header of a GUI in accordance with an exemplary embodiment of the present invention;

FIG. 30 depicts a public binders subfolder of the binders folder comprising coded metadata header of a GUI in accordance with an exemplary embodiment of the present invention;

FIG. 31 depicts a restricted binders subfolder of the binders folder comprising coded metadata header of a GUI in accordance with an exemplary embodiment of the present invention;

FIG. 32 depicts an all binders subfolder of the binders folder comprising coded metadata header of a GUI in accordance with an exemplary embodiment of the present invention;

FIG. 33 depicts a contacts/calendar folder of the menu tree expanded with subfolders and a calendar subfolder of the contacts/calendar folder with calendar features of a GUI in accordance with an exemplary embodiment of the present invention;

FIG. 34 depicts a my calendar subfolder of the contacts/calendar folder with calendar features of a GUI in accordance with an exemplary embodiment of the present invention;

FIG. 35 depicts a menu tree expanded of a GUI in accordance with an exemplary embodiment of the present invention;

FIG. 36 depicts a menu tree expanded (con't) of a GUI in accordance with an exemplary embodiment of the present invention;

FIG. 37 depicts a menu tree expanded (con't) of a GUI in accordance with an exemplary embodiment of the present invention;

FIG. 38 depicts a subfolder of the witness folder comprising organization and coded metadata header of a GUI in accordance with an exemplary embodiment of the present invention;

FIG. 39 depicts a defendant subfolder of the witness folder comprising coded metadata header of a GUI in accordance with an exemplary embodiment of the present invention;

FIG. 40 depicts a third party subfolder of the witness folder comprising coded metadata header of a GUI in accordance with an exemplary embodiment of the present invention;

FIG. 41 depicts a pleading subfolder of a subfolder subfolder of a plaintiff subfolder of the party folder comprising coded metadata header of a GUI in accordance with an exemplary embodiment of the present invention;

FIG. 42 depicts a declaration subfolder of a subfolder subfolder of a plaintiff subfolder of the party folder comprising coded metadata header of a GUI in accordance with an exemplary embodiment of the present invention;

FIG. 43 depicts a deposition exhibit subfolder of a subfolder subfolder of a plaintiff subfolder of the party folder comprising coded metadata header of a GUI in accordance with an exemplary embodiment of the present invention;

FIG. 44 depicts a hearing subfolder of a subfolder subfolder of a plaintiff subfolder of the party folder comprising coded metadata header of a GUI in accordance with an exemplary embodiment of the present invention;

FIG. 45 depicts a declaration subfolder of the type folder comprising coded metadata header of a GUI in accordance with an exemplary embodiment of the present invention;

FIG. 46 depicts an expert report subfolder of the type folder comprising coded metadata header of a GUI in accordance with an exemplary embodiment of the present invention;

FIG. 47 depicts a declaration subfolder of an exhibit subfolder of the type folder comprising coded metadata header of a GUI in accordance with an exemplary embodiment of the present invention;

FIG. 48 depicts a deposition subfolder of an exhibit subfolder of the type folder comprising coded metadata header of a GUI in accordance with an exemplary embodiment of the present invention;

FIG. 49 depicts a folder subfolder of a hearing subfolder of the type folder and a subfolder subfolder of a folder subfolder of a hearing subfolder of the type folder comprising coded metadata header of a GUI in accordance with an exemplary embodiment of the present invention;

FIG. 50 depicts a trial subfolder of a transcript subfolder of the type folder comprising coded metadata header of a GUI in accordance with an exemplary embodiment of the present invention;

FIG. 51 depicts a hearing subfolder of the event folder comprising coded metadata header of a GUI in accordance with an exemplary embodiment of the present invention;

FIG. 52 comprises a transcript subfolder of a trial subfolder of the event folder comprising coded metadata header of a GUI in accordance with an exemplary embodiment of the present invention;

FIG. 53 depicts a subfolder subfolder of a trial exhibit subfolder of the trial folder comprising coded metadata header of a GUI in accordance with an exemplary embodiment of the present invention;

FIG. 54 depicts a defendant subfolder of the deposition folder comprising coded metadata header of a GUI in accordance with an exemplary embodiment of the present invention;

FIG. 55 depicts a third party subfolder of the deposition folder comprising coded metadata header of a GUI in accordance with an exemplary embodiment of the present invention;

FIG. 56 depicts a correspondence subfolder of the case document folder comprising coded metadata header of a GUI in accordance with an exemplary embodiment of the present invention;

FIG. 57 depicts a correspondence subfolder of the case document folder comprising coded metadata header of a GUI in accordance with an exemplary embodiment of the present invention;

FIG. 58 depicts a formal paper subfolder of the case document folder comprising coded metadata header of a GUI in accordance with an exemplary embodiment of the present invention;

FIG. 59 depicts a legal memos subfolder of the case document folder comprising coded metadata header of a GUI in accordance with an exemplary embodiment of the present invention;

FIG. 60 depicts a my binders subfolder of the binders folder comprising coded metadata header of a GUI in accordance with an exemplary embodiment of the present invention;

FIG. 61 depicts a public binders subfolder of the binders folder comprising coded metadata header of a GUI in accordance with an exemplary embodiment of the present invention;

FIG. 62 depicts a restricted binders subfolder of the binders folder comprising coded metadata header of a GUI in accordance with an exemplary embodiment of the present invention;

FIG. 63 depicts an all binders subfolder of the binders folder comprising coded metadata header of a GUI in accordance with an exemplary embodiment of the present invention;

FIG. 64 depicts an all subfolder of the production folder comprising coded metadata header and features of a GUI in accordance with an exemplary embodiment of the present invention;

FIG. 65 depicts a hot document subfolder of the production folder comprising coded metadata header and features of a GUI in accordance with an exemplary embodiment of the present invention;

FIG. 66 depicts a sensitive subfolder of the production folder comprising coded metadata header and features of a GUI in accordance with an exemplary embodiment of the present invention;

FIG. 67 depicts a non-responsive subfolder of the production folder comprising coded metadata and features of a GUI in accordance with an exemplary embodiment of the present invention;

FIG. 68 depicts a responsive subfolder of the production folder comprising coded metadata header and features of a GUI in accordance with an exemplary embodiment of the present invention;

FIG. 69 depicts a pleading subfolder of the type folder comprising coded metadata header of a GUI in accordance with an exemplary embodiment of the present invention;

FIG. 70 depicts a pleading subfolder of the case document folder comprising coded metadata header and features of a GUI in accordance with an exemplary embodiment of the present invention; and

FIG. 71 depicts a network that supports an application comprising one or more of the GUIs described in the present invention.

### DETAILED DESCRIPTION OF THE INVENTION

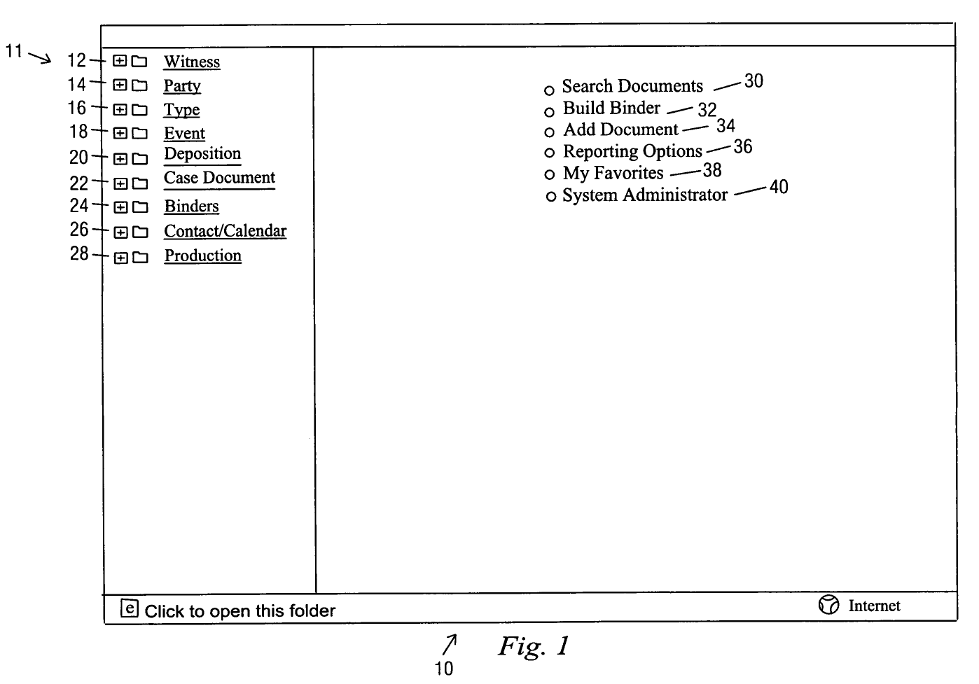

Referring now to FIG. 1, a main page and menu tree of a graphical user interface (GUI) 10 is presented. The GUI 10 is a portion of an application of the present invention that can be utilized by a user in order to perform various document management tasks. Prior to accessing such a GUI 10, which is preferably accessed via a web browser by at least one of a plurality of wireless and wired electronic devices, a login page (not shown) would be encountered. Other pages may further be encountered prior to accessing the GUI 10 such as a page allowing the user to select at least one particular event, such as a legal case, for example, and the documents related to that case.

The GUI 10 comprises a menu tree 11 that further comprises the following folders: Witness 12, Party 14, Type 16, Event 18, Deposition 20, Case Document 22, Binders 24, Contacts/Calendar 26, and production 28. The present invention is not constrained by the number of folders available in the menu tree 11. Other options on the GUI 10 include: Search Documents 30, Build Binder 32, Add Document 34, Reporting Options 36, My Favorites 38, and System Administration 40. A greater or lesser number of folders and options than those depicted, as well as differing titles and contents of the folders and options, may be associated with the GUI 10, the menu tree 11, and other GUIs described herein.

The user is able to access each of these folders and options (and other choices such as subfolders, documents, searching capabilities, etc. that will be described further herein) by positioning a cursor controlled by a mouse or stylus, for example, over the folder or option and engaging the folder or option.

The witness folder 12 contains links to each of a number of categories into which witnesses are categorized: Plaintiff, Defendant, Third Party, Expert, and All. Clicking on plaintiff will cause to be displayed a list of all witnesses in the case who are associated with the plaintiff. Clicking on defendant will cause to be displayed a list of all witnesses in the case who are associated with the defendant. Clicking on third party will cause to be displayed a list of all witnesses in the case who are associated with neither the plaintiff nor the defendant, nor those witnesses who are categorized as experts. Clicking on “all” will cause to be displayed a list of all witnesses entered into the database.

For any of the previous listings of witnesses, the following columns of information are displayed: Witness Name, Affiliation, Party, Role. Any of the headers for these columns may be clicked, which will then sort the listing of witnesses by the values contained in that column. Clicking a given column header a second, consecutive time will re-sort the list of witnesses by the values in that column, in opposite order.

Within the list, clicking on the name of a given witness, or the “Open” link on that witness's row, will cause to be displayed a listing of all documents in the database that are associated with that witness. Additionally present on the witness page is a section listing the Party Affiliation of the witness and the witness's Case Orientation, as well as contact information, including Title, Phone, Email, and Address.

The list of documents on the witness page is by section, based on document type. In this exemplary manifestation of the invention, the sections are Depositions, Exhibits, Declarations, Expert Reports, Testimony, and a final category for all other documents, “Additional Documents.” In each section, several columns of meta-data associated with each document are displayed. Clicking on any of the headers for these columns of metadata will cause the list to be sorted based on the values in that column. Clicking a second, consecutive time will cause the values to be sorted in reverse order.

Clicking on any “Open” link will cause the electronic representation of the document that particular line of metadata describes to be opened with a suitable document viewer plug-in. If the document that is being opened has any children documents (e.g. exhibits), a list of these will be displayed to the right of the document image, with each row of the related document listing containing a clickable link that, clicked upon, will cause to be displayed an electronic representation of that related document.

In any document-listing section throughout the database, such as those on the witness page, a checkbox resides on the row beside each listed document. One or more of these checkboxes can be selected on a given page, and then the “Add to Workspace” button at the top of the page clicked upon. When the “Add to Workspace” button is clicked upon, any document whose checkbox has been selected will be added to the workspace, which is a grouping of any number of documents the user has chosen to group at any given time, and may be accessed (by clicking on the “Workspace” link in the application header) for a number of purposes, including further grouping using the BinderBuilder feature; adding one or more of the grouped documents to a permanent grouping of “favorites” that the user may then easily access at any future time; and saving the grouping for retrieval at a later time.

The party folder 14 contains subfolders that represent each of the different categorizations for specific parties involved in the case. The current example contains categories and subfolders for Plaintiff and Defendant. Under each of these is listed the specific parties that are related. For Defendant, in this example, Microsoft is the related party. In addition to the specific party, other subcategories are listed. For Defendant, in this example, there are categories for Expert and Third Party. An All subcategory is also present. Microsoft and Third Party have the following subcategories: Pleading, Declaration, Deposition, Deposition Exhibit, Trial Exhibit, Hearing (which has a subcategory for each hearing in the case). The Expert item has the following subcategories: Declaration, Expert Report, Deposition, Deposition Exhibit.

Clicking on Pleading in any of the categories will cause to be displayed a list of metadata associated with documents designated as pleadings in the database, each of which must be related to each parent item of the Pleading item in the menu tree. For example, clicking on a Pleading item that is a subcategory of Microsoft, which is a subcategory of Defendant, will cause to be displayed a list of documents designated as pleadings that are associated with (filed by) only Defendant and Microsoft.

Clicking on Declaration in any of the categories will cause to be displayed a list of metadata associated with documents designated as declarations in the database, each of which must be related to each parent item of the Declaration item in the menu tree. For example, clicking on a Declaration item that is a subcategory of Microsoft, which is a subcategory of Defendant, will cause to be displayed a list of documents designated as declarations that are associated with only Defendant and Microsoft.

Clicking on Deposition in any of the categories will cause to be displayed a list of metadata associated with documents designated as depositions in the database, each of which must be related to each parent item of the Deposition item in the menu tree. For example, clicking on a Deposition item that is a subcategory of Microsoft, which is a subcategory of Defendant, will cause to be displayed a list of documents designated as depositions that are associated with only Defendant and Microsoft.

Clicking on Deposition Exhibit in any of the categories will cause to be displayed a list of metadata associated with documents designated as deposition exhibits in the database, each of which must be related to documents designated as depositions that are related to each parent item of the Deposition Exhibit item in the menu tree. For example, clicking on a Deposition Exhibit item that is a subcategory of Microsoft, which is a subcategory of Defendant, will cause to be displayed a list of documents designated as deposition exhibits that are associated with only those documents designated as depositions that are associated with Defendant and Microsoft.

Clicking on Trial Exhibit in any of the categories will cause to be displayed a list of metadata associated with documents designated as trial exhibits in the database, each of which must be related to each parent item of the Trial Exhibit item in the menu tree. For example, clicking on a Trial Exhibit item that is a subcategory of Microsoft, which is a subcategory of Defendant, will cause to be displayed a list of documents designated as trial exhibits that are associated with (filed by) only Defendant and Microsoft.

The Hearing subfolder in any of the categories has a listing of all hearings in the case. Clicking on any of these hearing items will cause to be displayed in the main section of the screen a listing of all metadata associated with documents related to the chosen hearing. Only those metadata that are related to the parent items of the chosen hearing will be displayed. For example, clicking on a hearing item that is a subcategory of Microsoft, which is a subcategory of Defendant, will cause to be displayed a list of documents that are associated with only Defendant and Microsoft.

Clicking on Expert Report in any of the categories will cause to be displayed a list of metadata associated with expert reports in the database, each of which must be related to each parent item of the Expert Report item in the menu tree. For example, clicking on an Expert Report item that is a subcategory of Expert, which is a subcategory of Defendant, will cause to be displayed a list of expert reports that are associated with only those experts in the database who are associated with Defendant.

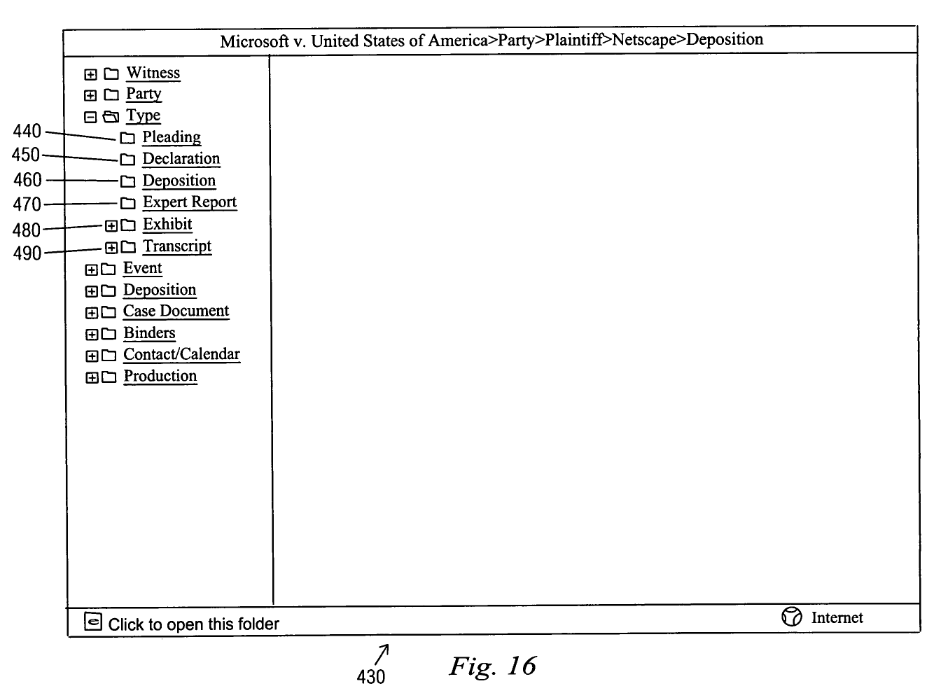

Referring now to the type folder 16 and further described in FIG. 16, a folder comprising subfolders and sub-items. The sub-items are: Pleading, Declaration, Deposition, Expert and Report. The subfolders are Exhibit and Transcript. Clicking on any of the sub-items (Pleading, Declaration, Deposition, and Expert Report) will cause to be displayed in the main portion of the screen a listing of meta-data describing all documents in the database that fall under the selected category.

Specifically, clicking on Pleading will cause to be displayed a row of metadata for each document that is designated a pleading in the database. As it exists in this example, the following columns of meta-data will be displayed for pleadings: Docket Number, Description, Date, Filed By, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

Clicking on Declaration will cause to be displayed a row of metadata for each document that is designated a declaration in the database. As it exists in this example, the following columns of meta-data will be displayed for declarations: Person, Affiliation, Date, Description, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

Clicking on Deposition will cause to be displayed a row of metadata for each document that is designated a deposition in the database. As it exists in this example, the following columns of meta-data will be displayed for depositions: Deponent, Affiliation, Party, Date, 30b6, Description, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

Clicking on Expert Report will cause to be displayed a row of metadata for each document that is designated an expert report in the database. As it exists in this example, the following columns of meta-data will be displayed for expert reports: Expert Name, Affiliation, Party, Date, Description, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

The Exhibit subfolder contains the sub-items Declaration, Deposition, and Trial. Also present is a subfolder: Hearing. The Hearing subfolder has a sub-item for each hearing in the database.

Clicking on any of the listed hearings (sub-items of Hearing) will cause to be displayed a row of metadata for each document that is designated an exhibit in the database and that is related to the selected hearing. There are no hearing sub-items in this particular example.

Clicking on Declaration will cause to be displayed a row of metadata for each document that is designated an exhibit in the database and that is related to a document that is designated in the database as a declaration. As it exists in this example, the following columns of meta-data will be displayed for the declaration exhibit item: Parent Document, Parent Doc Date, Exhibit, Exhibit Description, Bates Range, Exhibit Date, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

Clicking on Deposition will cause to be displayed a row of metadata for each document that is designated an exhibit in the database and that is related to a document that is designated in the database as a deposition. As it exists in this example, the following columns of meta-data will be displayed for the deposition exhibit item: Parent Document, Parent Doc Date, Exhibit, Exhibit Description, Bates Range, Exhibit Date, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

Clicking on Trial will cause to be displayed a row of metadata for each document that is designated an exhibit in the database and that is related to the Trial event in the database. As it exists in this example, the following columns of meta-data will be displayed for the trial exhibit item: Related Event, Event Date, Exhibit, Exhibit Description, Bates Range, Exhibit Date, Entered By, Date Admitted, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

The Transcript subfolder contains the sub-item Trial and the sub-folder Hearing. The Hearing subfolder has a sub-item for each hearing in the database. Clicking on any of the listed hearings (sub-items of Hearing) will cause to be displayed a row of metadata for each document that is designated a transcript in the database and that is related to the selected hearing. There are no hearing sub-items in this particular example. Clicking on the Trial sub-item will cause to be displayed a row of metadata for each document that is designated as a transcript in the database and that is related to the Trial event in the database. As it exists in this example, the following columns of metadata will be displayed for the trial transcript item: Related Event, Date, Description, Testimony By, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

The Event folder 18 contains two sub-folders: Trial and Hearing. The Hearing subfolder has a sub-item for each hearing in the database. Clicking on any of the listed hearings (sub-items of Hearing) will cause to be displayed a row of metadata for each document in the database and that is related to the selected hearing. There are no hearing sub-items in this particular example.

The Trial subfolder has a sub-item Transcript, a subfolder Trial Exhibit, and a sub-item Both. The Trial Exhibit subfolder has sub-items Plaintiff, Defendant, and All. Clicking on the Transcript sub-item will cause to be displayed a row of metadata for each document that is designated as a transcript in the database and that is related to the Trial event in the database. As it exists in this example, the following columns of metadata will be displayed for the trial transcript item: Related Event, Date, Description, Testimony By, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

Clicking on the Plaintiff or Defendant sub-items of Trial Exhibit will cause to be displayed a row of metadata for each document that is designated as an exhibit in the database, is related to the Trial event in the database, and is related to the selected sub-item (Plaintiff or Defendant). Clicking on the All sub-item of Trial Exhibit will cause to be displayed a row of metadata for each document that is designated as an exhibit in the database and is related to the Trial event in the database. As it exists in this example, the following columns of metadata will be displayed for these sub-items: Related Event, Date, Description, Testimony By, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

Clicking on the Both sub-item of Event will cause to be displayed a row of metadata for each document that is designated as an exhibit or a transcript in the database and is related to the Trial event in the database. As it exists in this example, the following columns of metadata will be displayed for these sub-items: Item Type, Date, Description, Exhibit, Bates Range, Entered By, Date Admitted, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

The Deposition folder 20 contains the following sub-items: Plaintiff, Defendant, Third Party, Expert, and All. Clicking on any of these sub-items will cause to be displayed a list of metadata associated with documents designated as depositions in the database, each of which must be related to each particular sub-item that was selected. For example, clicking on the Plaintiff sub-item will cause to be displayed a list of documents designated as depositions that are associated with only Plaintiff. Clicking on the All sub-item will cause to be displayed a list of metadata associated with documents designated as depositions in the database, without regard to other associations.

The Case Document folder 22 contains the following sub-items: Correspondence, Pleading, and Formal Paper. The Case Document folder also contains a subfolder, Work Product.

Clicking on the Correspondence sub-item will cause to be displayed a row of metadata for each document that is designated as correspondence in the database. As it exists in this example, the following columns of meta-data will be displayed for the correspondence item: Medium, Description, Date, Re, To, From, CC, BCC, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

Clicking on the Pleading sub-item will cause to be displayed a row of metadata for each document that is designated a pleading in the database. As it exists in this example, the following columns of meta-data will be displayed for pleadings: Docket Number, Description, Date, Filed By, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

Clicking on the Formal Paper sub-item will cause to be displayed a row of metadata for each document that is designated a formal paper in the database. As it exists in this example, the following columns of meta-data will be displayed for pleadings: Medium, Description, Date, Re, To, From, CC, BCC, as well as an “Open” link and a check-box for the Add to Workspace functionality previously described. Any of the headers for these columns may be clicked, which will then cause the listing to be sorted by the values contained in that column. Clicking a given column header a second, consecutive time will re-sort the list of metadata by the values in that column, in opposite order.

The Work Product subfolder has three sub-items: Order of Proof, Deposition Outline, and Legal Memos.

Clicking on the Order of Proof sub-item will cause to be displayed a row of metadata for each document that is designated an order of proof in the database. As it exists in this example, the following columns of meta-data will be displayed for order of proof: Description, Date, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

Clicking on the Deposition outline sub-item will cause to be displayed a row of metadata for each document that is designated a deposition outline in the database. As it exists in this example, the following columns of meta-data will be displayed for order of proof: Deponent, Description, Date, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

Clicking on the Legal Memos sub-item will cause to be displayed a row of metadata for each document that is designated a legal memo in the database. As it exists in this example, the following columns of meta-data will be displayed for legal memos: Description, Date, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

The LitBinders folder or menu item 24 has the following sub-items: My LitBinders, Public LitBinders, Restricted LitBinders, All LitBinders. This section of the menu tree deals with the concept of a LitBinder.

A LitBinder is a user-created, virtual grouping of documents. A user with access to the LitBinder can give the LitBinder a name, associate with it some descriptive text, change the ordering of the documents within the grouping, change the description of each element document, designate subsets of pages to extract for each element document, and generate an electronic compilation of all of the element documents' pages (the output is a single electronic file). All of this is done via the LitBinder manipulation GUI.

Clicking on the My LitBinders sub-item will cause to be displayed a row of metadata for each LitBinder in the database that has been created by the current user. For each LitBinder, the following metadata are displayed: ID (a unique id number that is associated with the LitBinder), Name (the user-designated name for the LitBinder), Owner (the user who created the LitBinder), Access (the level of access that the user has set for the LitBinder; this can be Public, Private, or Restricted), Description, Last Update (time stamp of last modification to the LitBinder). Any of the headers for these columns may be clicked, which will then sort the listing by the values contained in that column. Clicking a given column header a second, consecutive time will re-sort the list of metadata by the values in that column, in opposite order. There is also a link on each row for “View PDF,” which will cause to be displayed a single electronic file comprising all of the element documents of the LitBinder, and a link for “LitBinder Info,” which will cause to be displayed the LitBinder manipulation GUI for that LitBinder. There is also a checkbox on each row that, if checked when the user clicks the “Remove” link at the top of the page, will cause any rows whose checkboxes have been checked to be permanently removed from visibility.

Clicking on the Public LitBinders sub-item will cause to be displayed a row of metadata for each LitBinder in the database that has been designated Public (i.e. every user who has access to the case has access to that LitBinder). For each accessible LitBinder, the following metadata are displayed: ID (a unique id number that is associated with the LitBinder), Name (the user-designated name for the LitBinder), Owner (the user who created the LitBinder), Access (the level of access that the user has set for the LitBinder; this can be Public, Private, or Restricted), Description, Last Update (time stamp of last modification to the LitBinder). Any of the headers for these columns may be clicked, which will then sort the listing by the values contained in that column. Clicking a given column header a second, consecutive time will re-sort the list of metadata by the values in that column, in opposite order. There is also a link on each row for “View PDF,” which will cause to be displayed a single electronic file comprising all of the element documents of the LitBinder, and a link for “LitBinder Info,” which will cause to be displayed the LitBinder manipulation GUI for that LitBinder. There is also a checkbox on each row that, if checked when the user clicks the “Remove” link at the top of the page, will cause any rows whose checkboxes have been checked to be permanently removed from visibility.

Clicking on the Restricted LitBinders sub-item will cause to be displayed a row of metadata for each LitBinder in the database that has been designated Restricted (i.e. there is an explicit list of users who have access to that LitBinder; access is prohibited to any users not in that list) and where the current user's ID resides in the list of permitted IDs to access that LitBinder. For each accessible LitBinder, the following metadata are displayed: ID (a unique id number that is associated with the LitBinder), Name (the user-designated name for the LitBinder), Owner (the user who created the LitBinder), Access (the level of access that the user has set for the LitBinder; this can be Public, Private, or Restricted), Description, Last Update (time stamp of last modification to the LitBinder). Any of the headers for these columns may be clicked, which will then sort the listing by the values contained in that column. Clicking a given column header a second, consecutive time will re-sort the list of metadata by the values in that column, in opposite order. There is also a link on each row for “View PDF,” which will cause to be displayed a single electronic file comprising all of the element documents of the LitBinder, and a link for “LitBinder Info,” which will cause to be displayed the LitBinder manipulation GUI for that LitBinder. There is also a checkbox on each row that, if checked when the user clicks the “Remove” link at the top of the page, will cause any rows whose checkboxes have been checked to be permanently removed from visibility.

Clicking on the All LitBinders sub-item will cause to be displayed a row of metadata for each LitBinder in the database that the current user has access to. This includes a) LitBinders the current user has created; b) LitBinders designated Restricted and where the current user's ID resides in the list of permitted IDs to access that LitBinder; and c) LitBinders designated Public. For each accessible LitBinder, the following metadata are displayed: ID (a unique id number that is associated with the LitBinder), Name (the user-designated name for the LitBinder), Owner (the user who created the LitBinder), Access (the level of access that the user has set for the LitBinder; this can be Public, Private, or Restricted), Description, Last Update (time stamp of last modification to the LitBinder). Any of the headers for these columns may be clicked, which will then sort the listing by the values contained in that column. Clicking a given column header a second, consecutive time will re-sort the list of metadata by the values in that column, in opposite order. There is also a link on each row for “View PDF,” which will cause to be displayed a single electronic file comprising all of the element documents of the LitBinder, and a link for “LitBinder Info,” which will cause to be displayed the LitBinder manipulation GUI for that LitBinder. There is also a checkbox on each row that, if checked when the user clicks the “Remove” link at the top of the page, will cause any rows whose checkboxes have been checked to be permanently removed from visibility.

The LitBinder manipulation GUI is accessible from the LitBinder listings above or from the Workspace, wherein a user has selected one or more documents from anywhere else in the system, and then clicked the “Create LitBinder” link. If the LitBinder GUI has been accessed by clicking on the LitBinder Info link for an existing LitBinder on a LitBinder listing, the GUI will appear as above, with the various fields containing the information that was last entered and saved for this LitBinder. If the LitBinder GUI has been accessed by using the Create LitBinder link on the workspace GUI, all of the fields will be empty, with the exception of the Document Description fields, which will contain the contents of the metadata field description for each element document. This GUI is where various manipulations of LitBinders occur. The value of the Update Existing checkbox signifies whether or not, when the Save link is clicked, the contents of the fields in the GUI should be applied to an existing LitBinder, or whether a new LitBinder should be created. If the Update Existing checkbox is clicked, the “LitBinder:” field to the right of the checkbox will be visible, and contain a list of all LitBinders that the current user has access permissions to. If the LitBinder GUI has been accessed by clicking on the “LitBinder Info” link for an existing LitBinder, the name of that LitBinder will be selected by default. Selecting any LitBinder name from this list will cause the LitBinder GUI to be re-opened, displaying all of the original metadata for the selected LitBinder, with the addition of the contents of the Included Documents section displayed prior to selecting the LitBinder from the “LitBinder:” selection list.

The Name field contains a user-defined name for the displayed LitBinder, and the Description field contains user-defined text.

The Access section contains three radio-button selections that are used to designate the permissions attributed to the displayed LitBinder. If Private is selected, the LitBinder will be visible to only the current user. If Public is selected, the LitBinder will be visible to any user having access to the database. If Restricted is selected, two additional list boxes appear to the right, with “add” and “remove” links between them. All users with access to the database are listed in the leftmost box; highlighting any of these user names and clicking the “add” link will copy the user name to the rightmost list box. Highlighting one or more user names in the rightmost list box and selecting the “remove” link will cause the selected names to be removed from the listing in the rightmost box. When the LitBinder has been saved, only the current user (owner) and those users whose names appear in the rightmost box will be able to access the LitBinder.

The Owner section displays the name of the user who created the LitBinder, and the Last Updated section displays the date and time the LitBinder was last saved.

The “Included Documents” section contains a list of documents from the database that the user has selected to be included in the virtual grouping that is this LitBinder. Each row contains a reference to an existing document from the database. The First column is titled “Move” and contains four arrow icons. Clicking on the first arrow icon in any given row will cause the contents of that row to be shifted to the top of the list of rows; all other rows will be shifted down one, accordingly. Clicking on the second arrow icon in any given row will cause the contents of that row to be shifted up one row in the list. Clicking on the third arrow icon in any given row will cause the contents of that row to be shifted down one row in the list. Clicking on the fourth arrow icon in any given row will cause the contents of that row to be shifted to the bottom of the list of rows; all other rows in the list will be shifted up one, accordingly.

The second column in the Included Documents section is titled “View,” and this column contains an “Open” link on each row. Clicking on this link in any given row will cause to be displayed an electronic representation of the document the row's metadata describe.

The third column in the Included Documents section is titled “Date,” and this column contains on each row the contents of the metadata field designated “Date” for the document associated with that row's metadata. Clicking on the column header will cause the list of Included Documents to be sorted by the values in the “Date” column for each row. Clicking on the column header a second, consecutive time will cause the contents of the section to be re-sorted in reverse order, based on the values in the Date column for each row.

The fourth column in the Included Documents section is titled “Document Description.” For each row in the list, this column contains an editable box. The contents of this box are set by default to the contents of the “Description” metadata field for the document that row represents. Users may change the contents of this box to anything. Clicking on the column header for “Document Description” will cause the rows of the listing to be sorted by the contents of this field. Clicking on the column header a second, consecutive time will cause the rows of the listing to be sorted by the contents of this field, in reverse order.

The fifth column in the Included Documents section is titled “Pages,” and this column contains on each row an editable box that defaults to the value “all.” Beside the box is text that describes the maximum number of pages that are possible. A user can change the value in the Pages box on any row to reflect the page numbers that will be included when the electronic compilation of the document is generated and displayed by clicking on the “View” link at the bottom of the LitBinder manipulation GUI. The header of this column cannot be clicked for sorting.

The sixth column in the Included Documents section is titled “Remove.” For each row, this column contains a button with the text “Remove.” If a user clicks this button for a given row, the contents of that row are removed from the listing.

Below the Included Documents section, there is a link for “Add Document from Workspace.” For a given LitBinder, clicking on this link will cause the Workspace GUI to be displayed, at which time the user will have the option to select one or more documents that are referenced in the Workspace, and then click an “Add to LitBinder” link. Upon clicking the “Add to LitBinder” link from the Workspace, the previously displayed LitBinder GUI will be restored, with any documents selected in the Workspace GUI added to the bottom of the list of Included Documents on the LitBinder GUI.

The following links are present at the bottom of the LitBinder GUI: Save As New, Save, View, Discard Changes. Activating the “Save As New” link will cause a new LitBinder to be created in the database with exactly the same information as the LitBinder being viewed at the time the link is selected. Activating the Save link will cause the current configuration of the LitBinder GUI to be saved to the database. Activating the “View” link will cause to be created an electronic compilation of all of the included documents of the LitBinder. The electronic compilation will include an additional page before each component document, displaying the contents of the “Document Description” column for the document. The electronic compilation may then be viewed, saved to disk, emailed or any other action that is possible with an electronic file. The Discard Changes link will cause the LitBinder GUI to refresh all fields to their most recently saved values. Any changes that have been made in the LitBinder GUI since the last time the LitBinder was saved will be reversed.

The Contacts/Calendar folder or menu item 26 has the following sub-items: Calendar, My Calendar, Contacts.

Clicking on the Calendar sub-item will cause to be displayed a monthly calendar for the current month. Each day of the month has its own box. Each daily box displays a day of the month, which is a clickable link. A short description for any event in the database that is viewable publicly will be present in the daily box for each day within which the event takes place, and within any hourly section on the hourly calendar for a day in which the event spans. Each daily box also has a “new” link. Clicking on the “new” link will cause to be displayed the Add Event GUI. The Add Event GUI comprises the following fields: Event Name, Location, Start Date, End Date, Start Time, End Time, Private Event, and Description. The contents of any of these fields can be manipulated by the user. The Private Event checkbox determines whether or not the event is visible only on the Calendar of the user who created the event. Clicking the Add Event button will cause the contents of the fields to be saved to the database. The event will then appear as appropriate on the monthly and daily calendars. Clicking on the day of the month will cause to be displayed an hourly view of the day that was clicked.

The monthly and daily calendars also have horizontal arrow links in the upper right- and left-hand corners. Clicking on the left arrow in the monthly view will cause the view to change to the previous month. Clicking on the right arrow in the monthly view will cause the view to change to the next chronological month. Clicking on the left arrow in the daily calendar will cause the view to change to the previous day. Clicking on the right arrow in the daily calendar will cause the view to change to the next chronological day.

The monthly calendar also has a “Go to:” section at the bottom of the GUI. It is comprised of two drop-down selection boxes and a button titled “Go.” The first drop-down selection box contains a list of the months of the year. The second drop-down selection box contains a list of the years 15 years prior to the currently displayed year, as well as those years up to 15 years in the future from the currently displayed year. Both selection boxes default to the values equal to the date currently being displayed in the calendar. Changing either of these and clicking the “Go” button will cause the calendar display to switch to the month and year selected in those drop-down selection boxes.

The day calendar has two links at the top of the GUI: “new event” and “month.” Clicking on the “new event” link will cause the New Event GUI to be displayed. Clicking on the “month” link will cause the view to switch to the monthly calendar view for the date currently displayed.

Clicking on the “My Calendar” sub-item will have the same effect as clicking on the “Calendar” sub-item, with the exception that the events displayed in the calendar are restricted to only those events that the current user has created.

Clicking on the “Contacts” sub-item will cause to be displayed an electronic representation a document containing information that typically concerns contact information for persons involved in the litigation case.

In this example, the Production folder or menu item 28 has the following subfolders: Plaintiff, Defendant, and All. In this example application, each of these subfolders has the following sub-items: All, Hot Document, Sensitive, Non-Responsive, Responsive.

Clicking on any of these sub-items will cause to be displayed a list of documents in the database that have been designated as production. The contents of the list are determined by the sub-item clicked upon. Each production document in the database is associated with one or more Production Source objects. Each production document further may be associated with one or more “Quick-Note” flags that users set.

With the exception of the All sub-item, when any given Production sub-item is clicked upon, only those documents will be displayed that are designated as production, are associated with the production source corresponding to the parent of the clicked sub-item, and have been associated with the quick-note corresponding to the sub-item clicked upon. When the All sub-item is clicked upon, all documents that are designated as production and associated with the production source corresponding to the parent of the clicked sub-item will be displayed.

The display for all of these sub-items is the same, and includes the following columns: Description, Date, Bates Begin, Bates End, Date Produced, Quick-Note, Text Note, as well as an “Open” link and a check-box for the Add to Workspace functionality previously described. Any of the headers for these columns may be clicked, which will then sort the listing by the values contained in that column. Clicking a given column header a second, consecutive time will re-sort the list of metadata by the values in that column, in opposite order.

The Quick-Note column contains a blue triangular link that, when activated, will cause to be displayed a history of modifications to that row's document's quick-note selections. The history includes the user who made the change, the value that the quick-note was changed to, and the date and time the change was made. Beside the blue triangular link, each quick-note that is currently applied to that row's document is displayed. If more than one quick-note is attributed to the document, all of the quick-note names will be displayed. If no quick-notes are attributed to that row's document, an “Edit” link will be displayed instead. Clicking on any of these links will cause to be displayed a selection box that includes all of the available quick-note values. One or more of these values can be selected by the user. When the “Save” button is activated, the associations are written to the database and the main view of the Production documents is refreshed to reflect the new values.

The Text Note column displays on each row an “Edit” link if no text note is currently associated with the document represented on that row. If a text note is currently associated with the document represented by that row, the text of that note will be displayed instead. When clicked, either the edit link or the text note's text will cause to be displayed a GUI with the following elements: a user-modifiable box, un-modifiable text listing the user who most recently modified the text, and the date and time at which the text note was most recently modified, as well as a save button, a cancel button, and a delete button. When the save button is activated, the text in the text box is written to the database, the text note GUI is closed, and the main production display is updated to reflect the revised text note. When the cancel button is activated, the text note GUI is closed, no information is written to the database, and the main production display is not updated. When the delete button is activated, the text note GUI is closed, any existing text note entry for is cleared from the database for the document, and the main production display is updated to reflect the revised text note.

In one embodiment of the present invention, a method for managing documents comprises associating a first document in a first category with a second document in a second category, and grouping the documents, wherein the first document and the second document contain at least one related item, wherein the first document and the second document are unrelated, and wherein the categories are related or unrelated. The method further comprises associating a plurality of documents in a first category with a plurality of documents in a plurality of categories.

In another embodiment of the present invention, a computer readable medium comprises instructions for associating a first document in a first category with a second document in a second category, wherein the first document and the second document have at least one related item, and wherein the categories are separate, grouping the documents, and creating a binder including the grouped documents, wherein the binder is portable. The computer readable medium of claim 7 further comprising instructions for assigning access privileges to the documents. The computer readable medium, or software which is adapted to run on a wireless or wired electronic device (such as a PC or mobile phone, for example) further comprises instructions for: processing changes to the categories, wherein the changes include at least one of a following item from a group consisting of: altering the categories, adding other categories, and removing the categories, and dynamically generating data entry fields based on at least one of a following action from a group consisting of: accessing the documents, changing data within the documents, accessing the binder, changing data within the binder, adding other documents, and adding other data.

In a further embodiment, a system comprises a method for entering data relating to a document, comprises dynamically generating a layout of fields for data entry, based on a type of document chosen and on a specific template that is selected; retrieving a pre-configured template containing a list of relevant fields, and directions for writing their contents to a database, wherein the relevant fields are related to the fields laid out for data entry; and writing the contents of the relevant fields to the database. The method further comprises: adding fields to be dynamically generated in the layout, receiving contents of the fields, defaulting to contents related to the fields, retrieving an action associated with a field of the relevant fields, wherein the action is defined in a first module (a web service on the web server), sending at least one of a following element from a second module (a client) to a third module (a server) from a list comprising: the action, an attribute type relating to the field, an identification of the document, and a content of the field to be entered, supplying contents related to the action, by the first module to the third module, receiving a message by the second module related to the supplied contents.

The present invention includes sets of metadata that are displayed in a specific kind of formatted list, referred to as a DataTable. A DataTable is a flexible mechanism for displaying rows and columns of information. Each DataTable is generated by means of consulting a template. Each time the system needs to generate a DataTable, it consults a certain template based on the context of the request. For example, most menu-tree items are associated with a template. Whenever one of these menu-tree items is clicked upon, the system consults its associated template and renders a table of information whose data have been generated based on instructions in the template. The layout of the rendered information is also specified by the template. For example, the number of columns that are displayed and what information is contained in each column. The template generally also specifies the ability for certain columns to be sortable (that column's header can be clicked on by a user), and the rows in the table will be reordered based on the values in that column. Clicking the column's header a second, subsequent time will re-sort the rows based on the values in that column, but in reverse order.

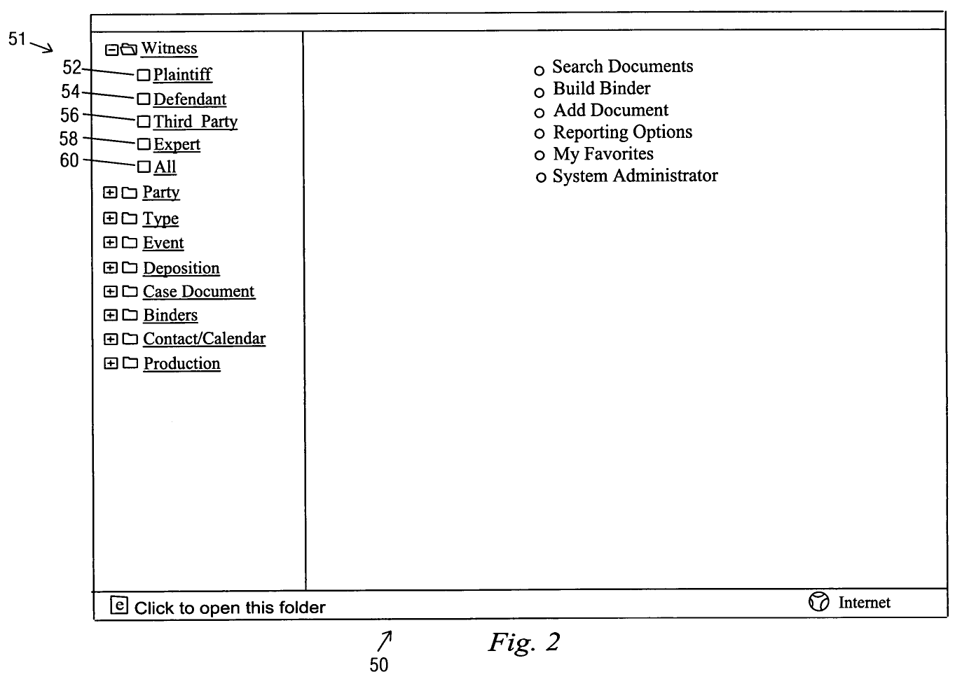

Referring now to FIG. 2 a witness folder of the menu tree 11 and an expanded view of the witness subfolders 51 of a GUI 50 is presented. The subfolders include: Plaintiff 52, Defendant 54, Third Party 56, Expert 58, and All 60.

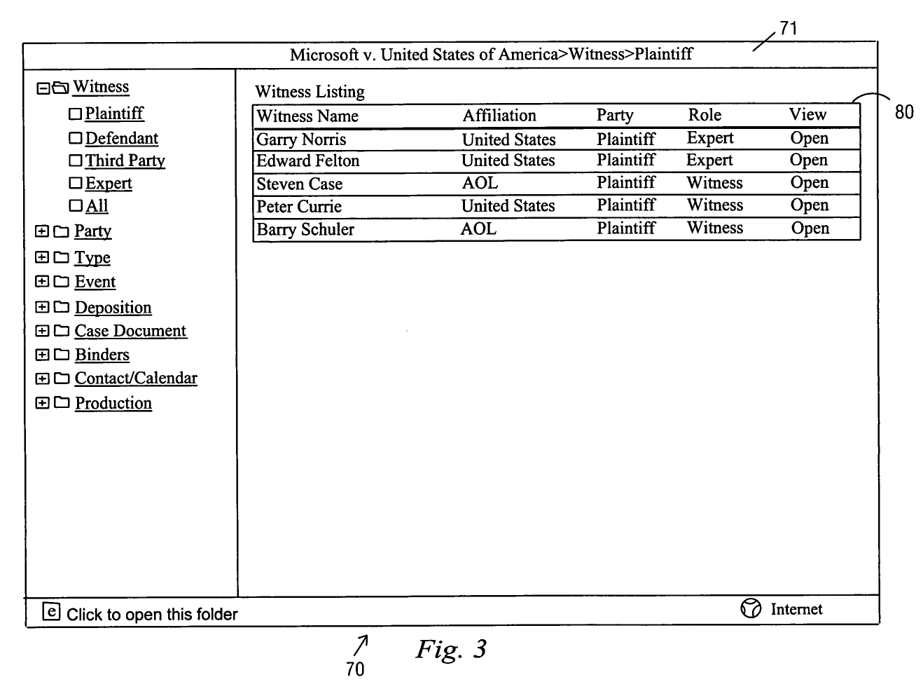

Referring now to FIG. 3 a GUI 70 depicts the plaintiff subfolder 52 that contains information 80 relating to a Witness Name, their Affiliation (such as the company they are employed by), their Party (in this case, the witness would be a plaintiff), their Role (such as an expert, or witness), and the ability to View the document containing the deposition of the witness or expert. This, as well as other documents, may be added to a “cart” (described below) and thus placed in a common location for future access.

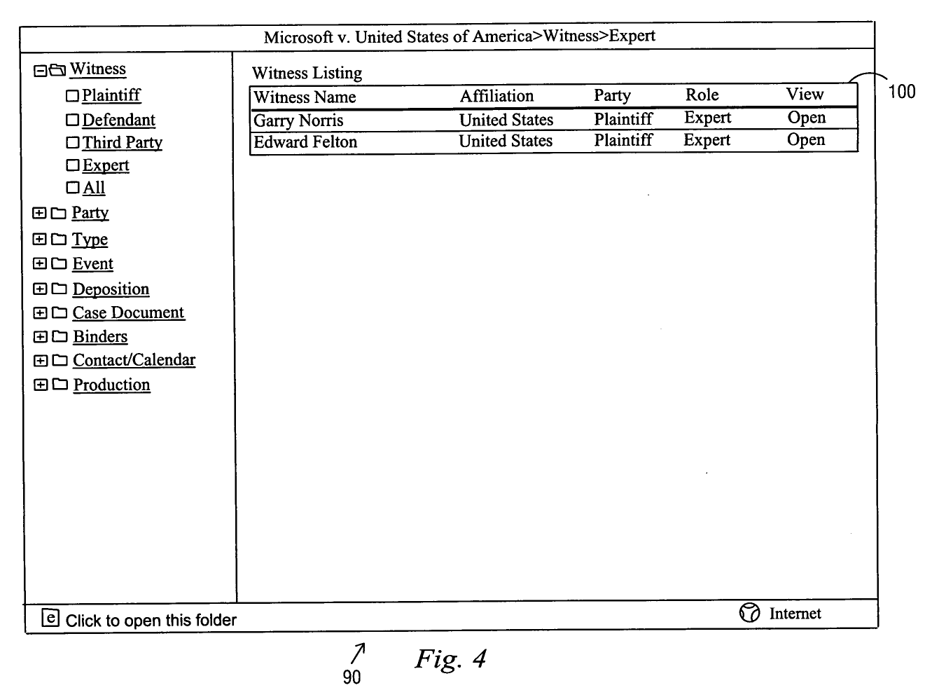

FIG. 4 depicts an expert subfolder of the witness folder comprising coded metadata header of a GUI in accordance with an exemplary embodiment of the present invention.

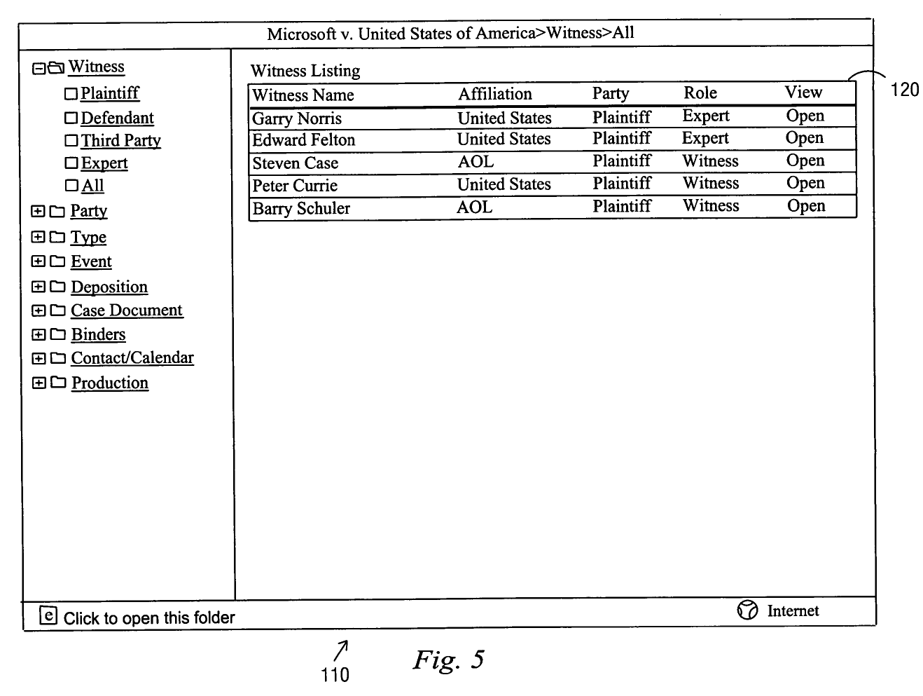

FIG. 5 depicts an all subfolder of the witness folder comprising coded metadata header of a GUI in accordance with an exemplary embodiment of the present invention.

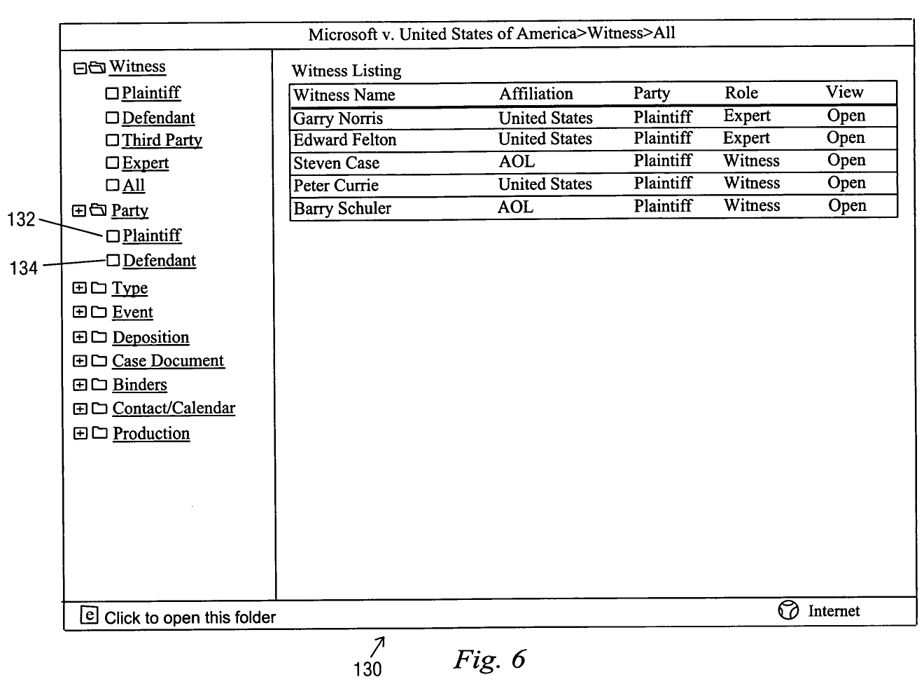

FIG. 6 depicts a party folder of the menu tree and an expanded with main subfolders of a GUI in accordance with an exemplary embodiment of the present invention.

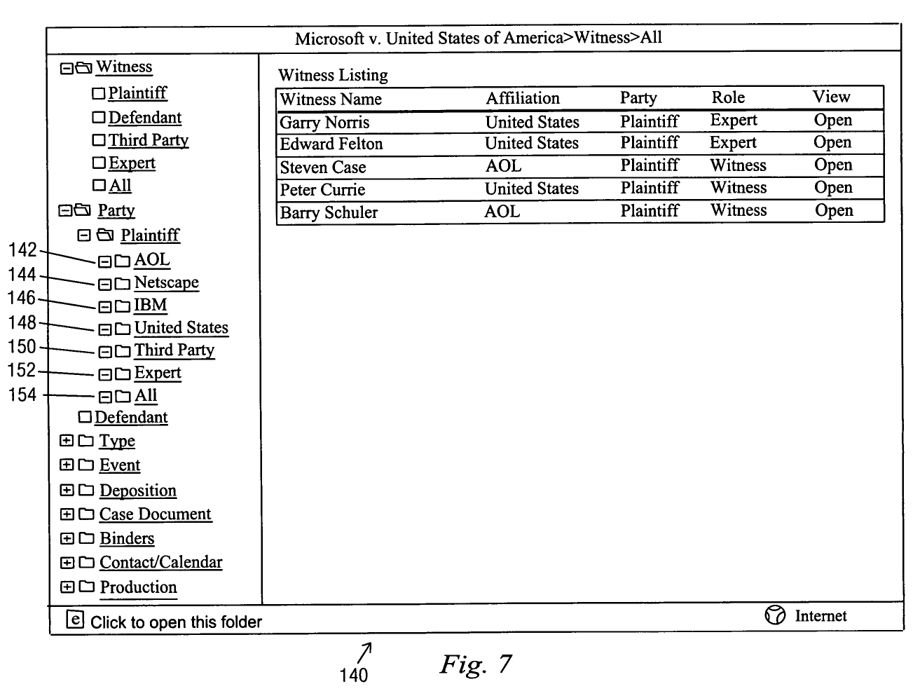

FIG. 7 depicts a plaintiff subfolder of the party folder with expanded subfolders of a GUI in accordance with an exemplary embodiment of the present invention.

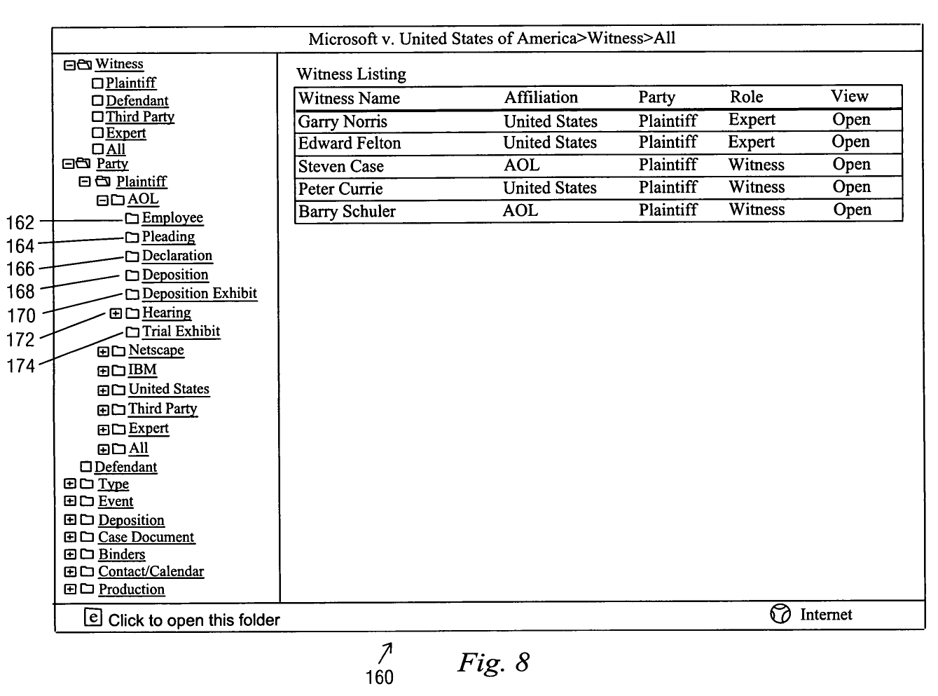

FIG. 8 depicts a plaintiff subfolder of the party folder with expanded subfolder of a GUI in accordance with an exemplary embodiment of the present invention.

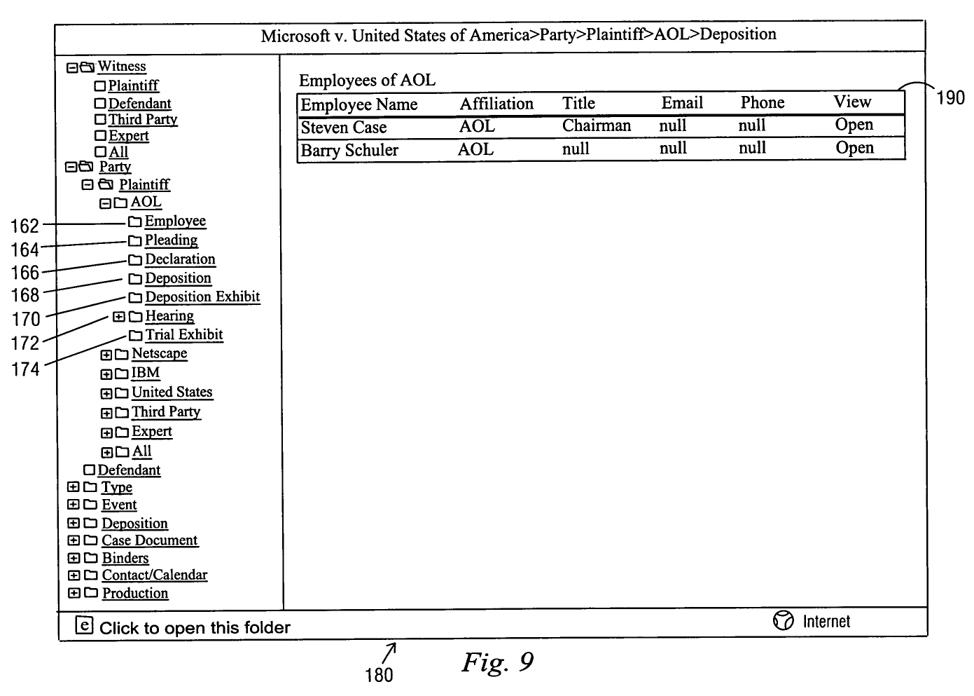

FIG. 9 depicts a subfolder subfolder of a plaintiff subfolder of the party folder with employee coded metadata header of a GUI in accordance with an exemplary embodiment of the present invention.

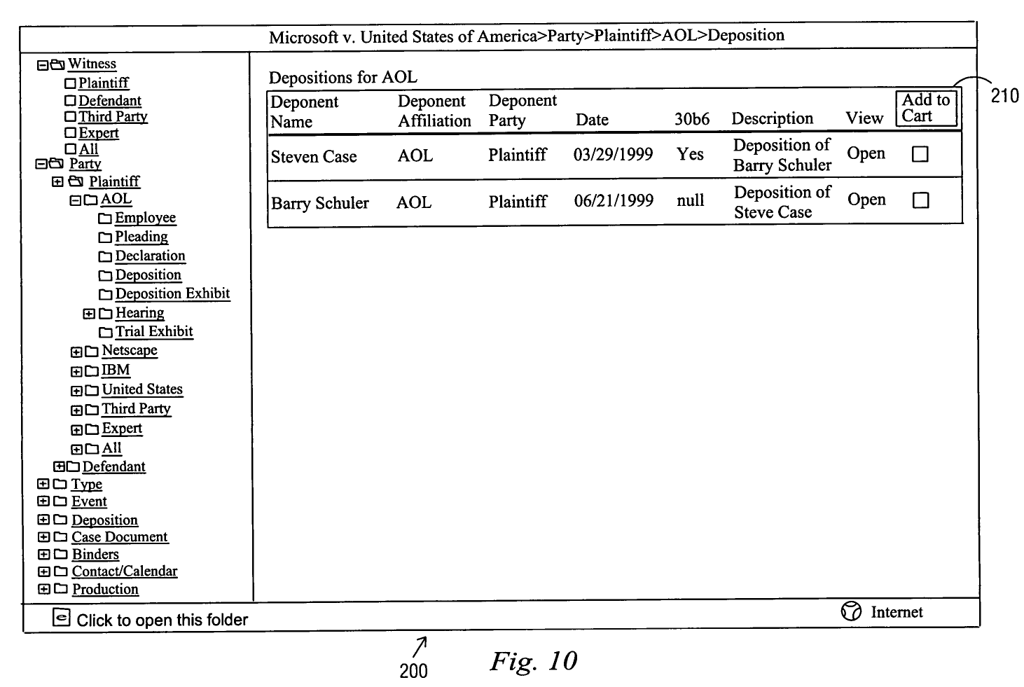

FIG. 10 depicts a subfolder subfolder of a plaintiff subfolder of the party folder with deposition coded metadata header of a GUI in accordance with an exemplary embodiment of the present invention.

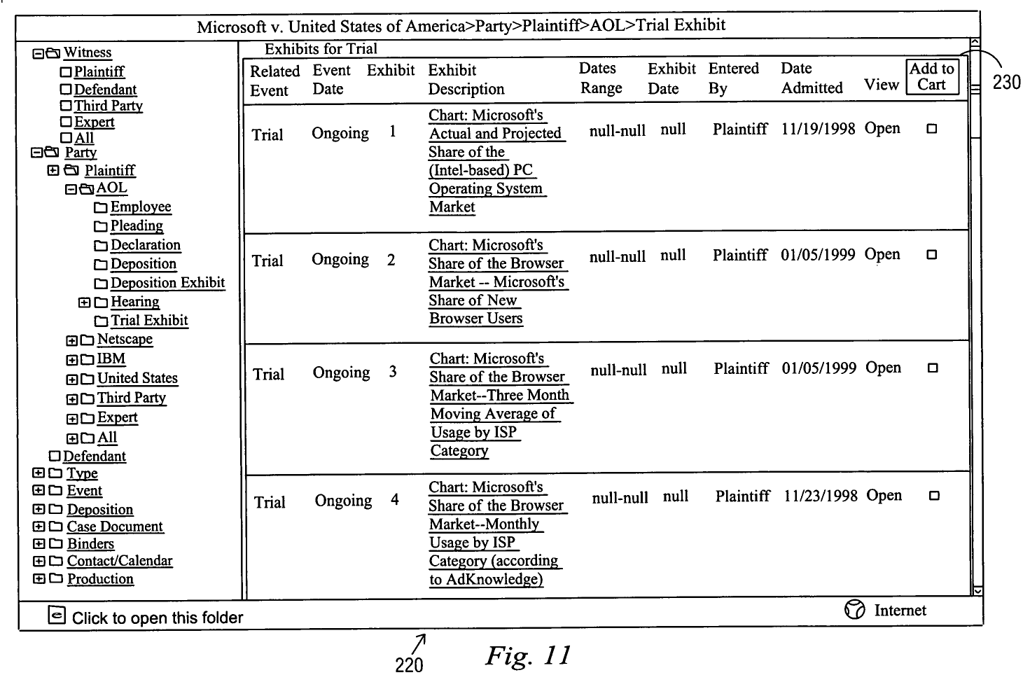

FIG. 11 depicts a subfolder subfolder of a plaintiff subfolder of the party folder with a trial exhibit coded metadata header of a GUI in accordance with an exemplary embodiment of the present invention.

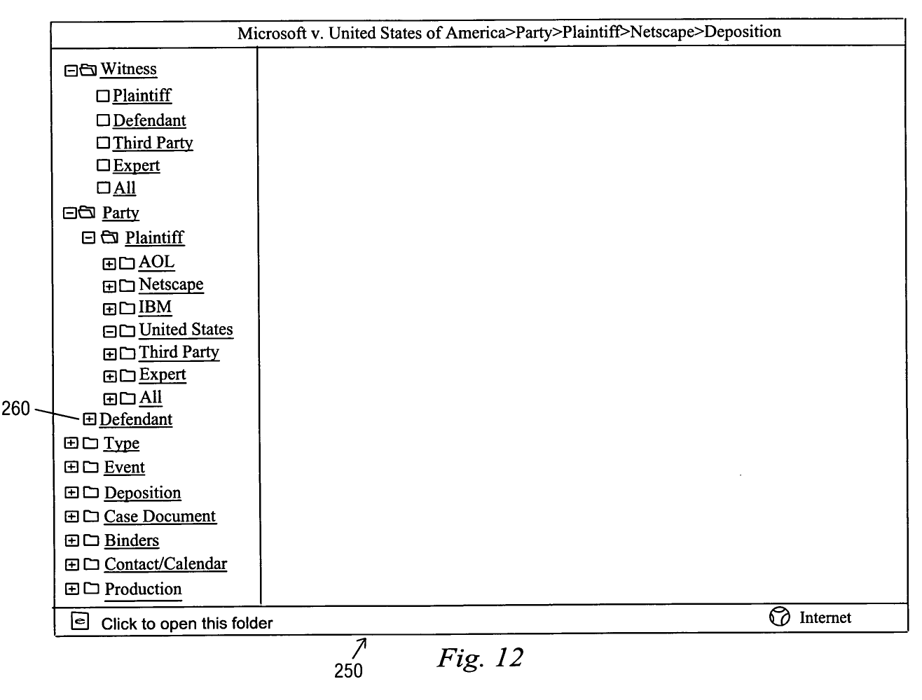

FIG. 12 depicts a defendant subfolder of the party folder of a GUI in accordance with an exemplary embodiment of the present invention.

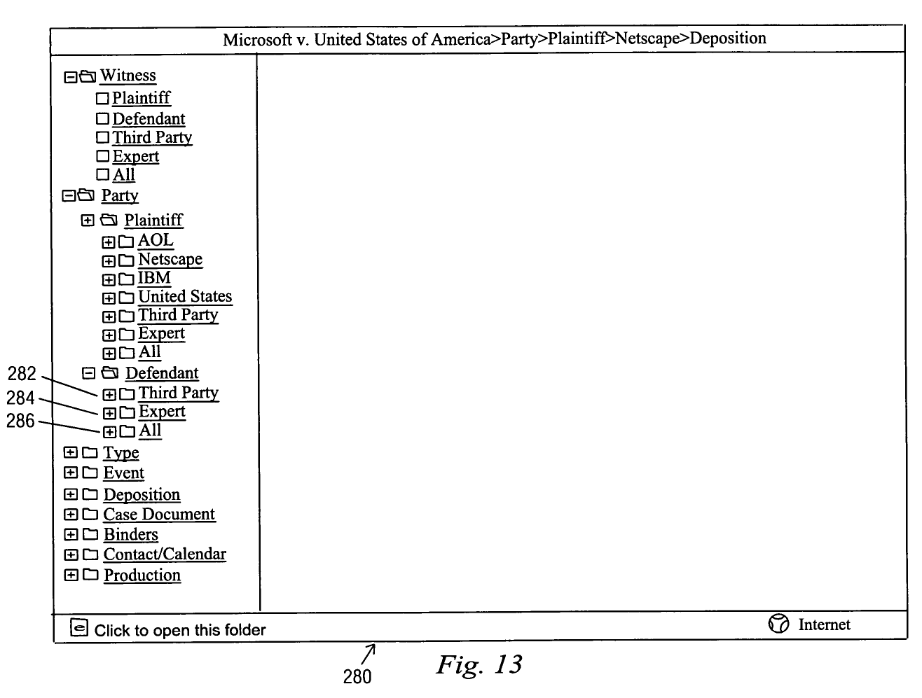

FIG. 13 depicts a subfolder subfolder of a defendant subfolder of the party folder of a GUI in accordance with an exemplary embodiment of the present invention.

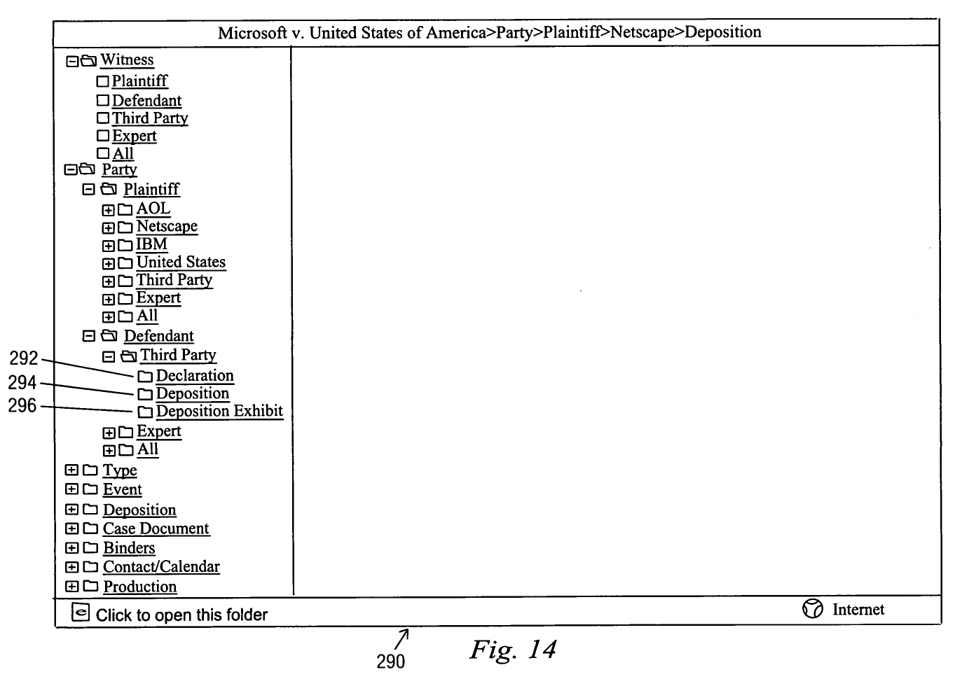

FIG. 14 depicts a third party subfolder of a defendant subfolder of the party folder with expanded subfolders of a GUI in accordance with an exemplary embodiment of the present invention.

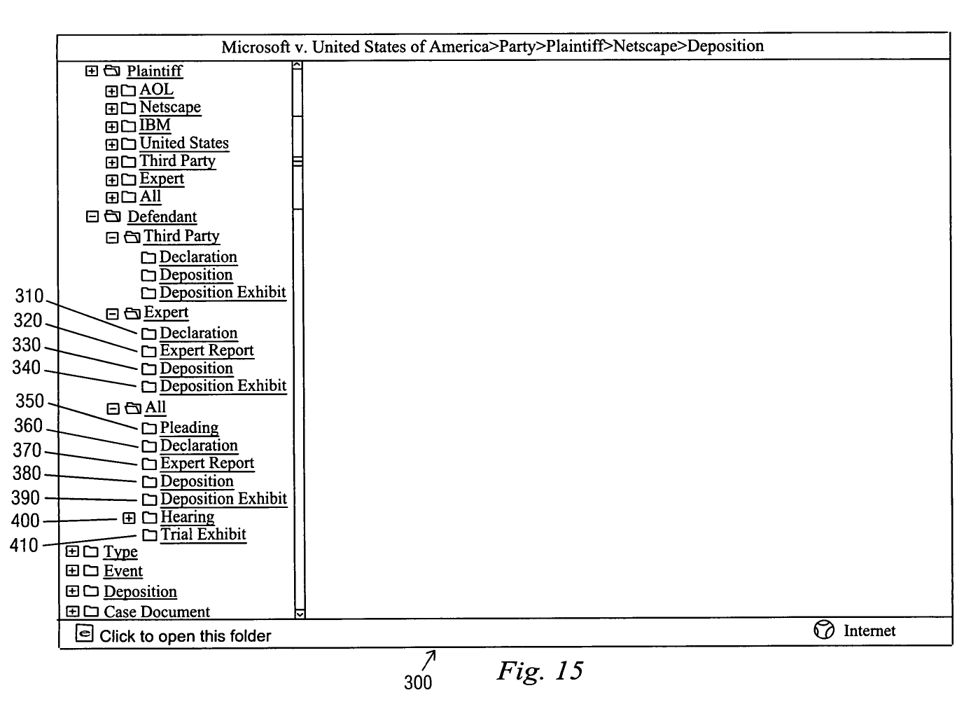

FIG. 15 depicts a defendant folder with expanded subfolders of a GUI in accordance with an exemplary embodiment of the present invention.

FIG. 16 depicts a type subfolder of the menu tree folder comprising subfolders of a GUI in accordance with an exemplary embodiment of the present invention.

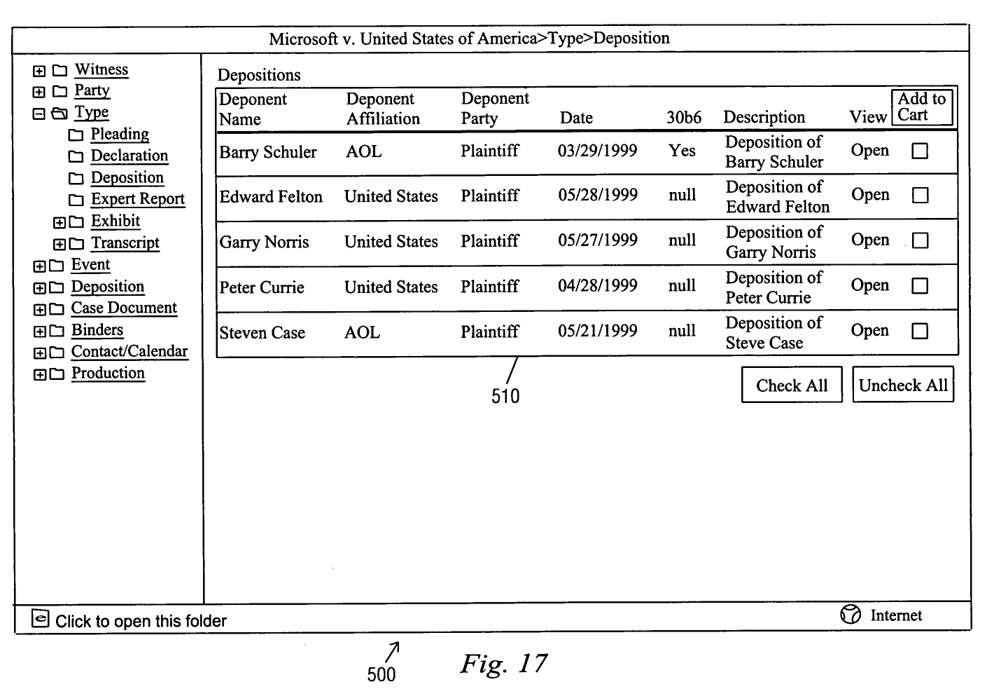

FIG. 17 depicts a deposition subfolder of the type folder comprising coded metadata header of a GUI in accordance with an exemplary embodiment of the present invention.

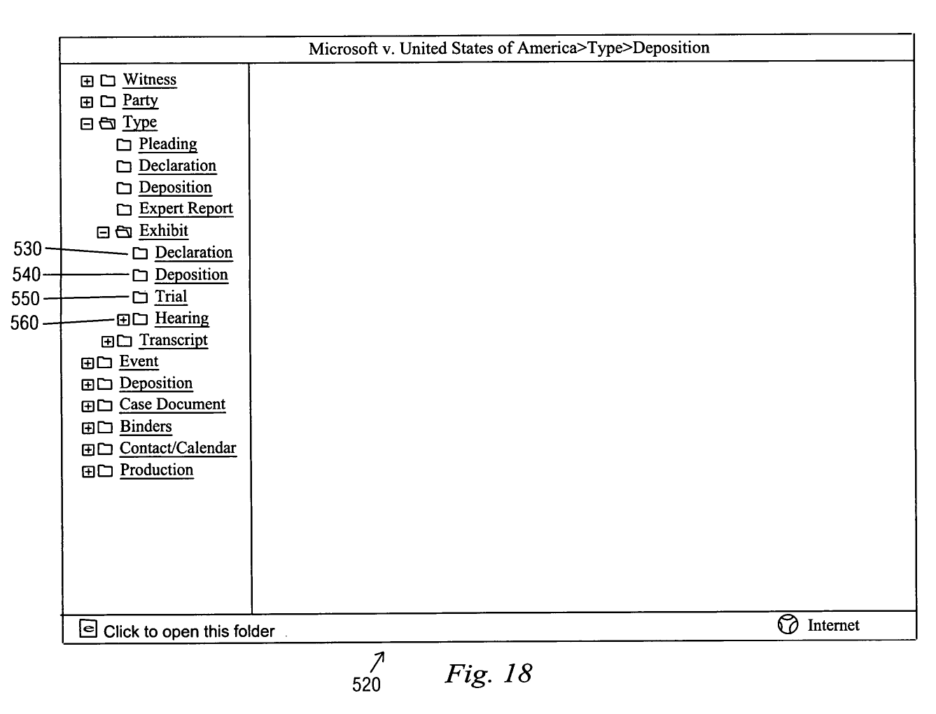

FIG. 18 depicts an exhibit subfolder of the type folder expanded with subfolders of a GUI in accordance with an exemplary embodiment of the present invention.

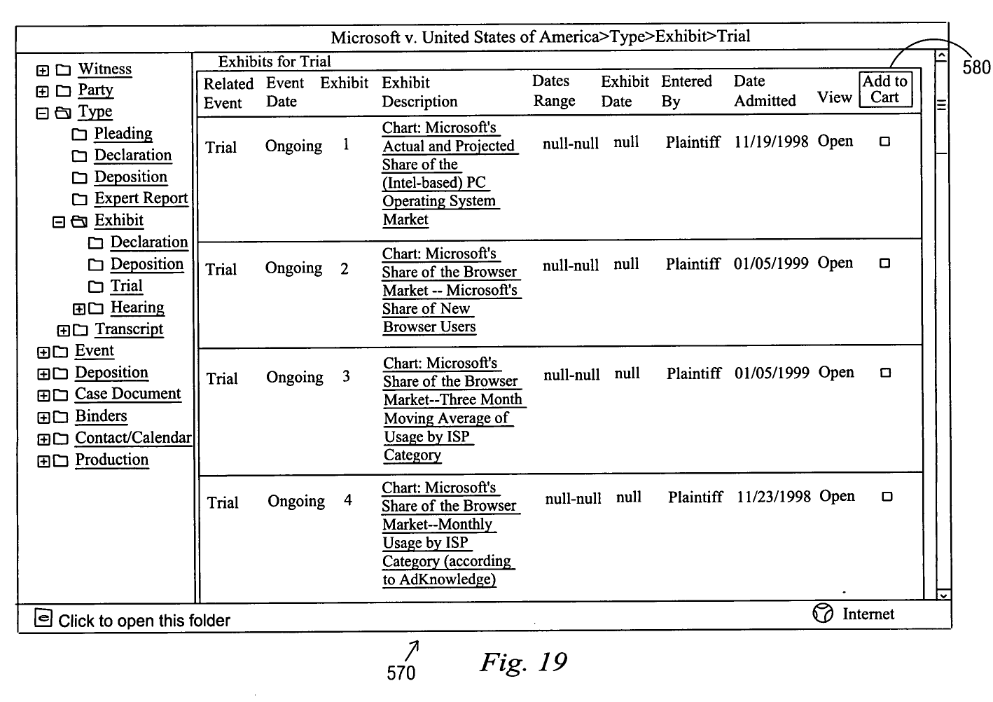

FIG. 19 depicts a trial subfolder of an exhibit subfolder of the type folder comprising coded metadata header of a GUI in accordance with an exemplary embodiment of the present invention.

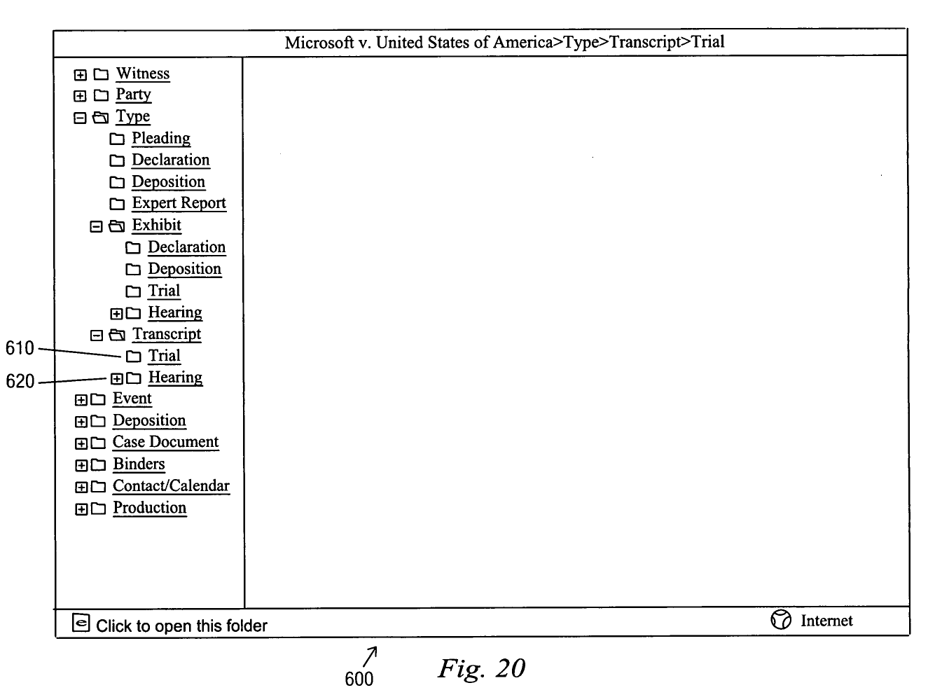

FIG. 20 depicts a transcript subfolder of the type folder expanded with subfolders of a GUI in accordance with an exemplary embodiment of the present invention.

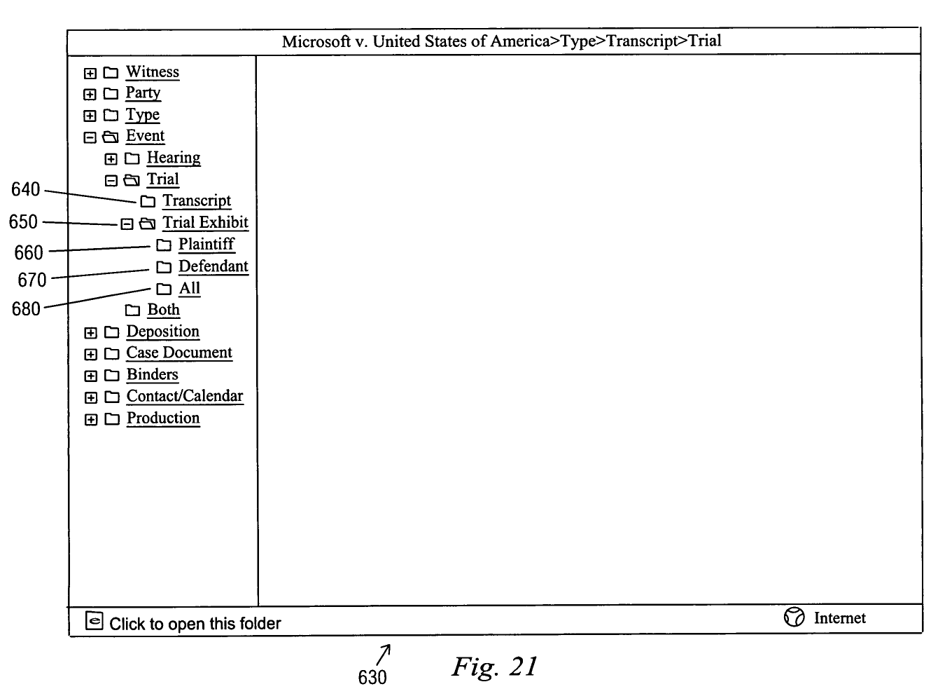

FIG. 21 depicts an event folder of the menu tree and expanded folders and subfolders of a GUI in accordance with an exemplary embodiment of the present invention.

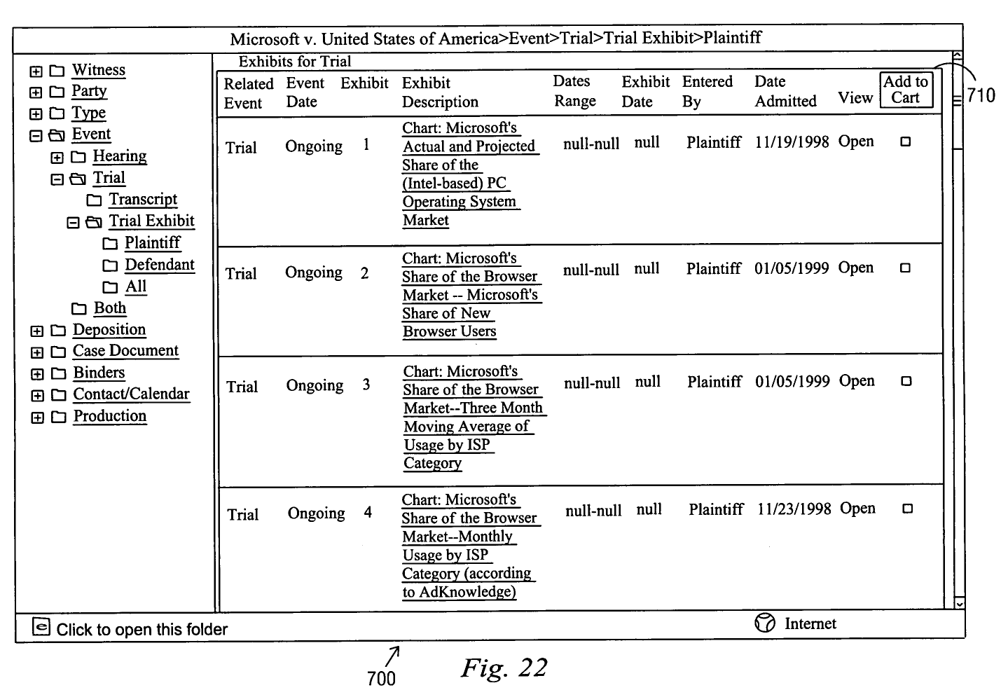

FIG. 22 depicts a plaintiff subfolder of a trial exhibit subfolder of the trial subfolder of the event folder comprising coded metadata header of a GUI in accordance with an exemplary embodiment of the present invention.

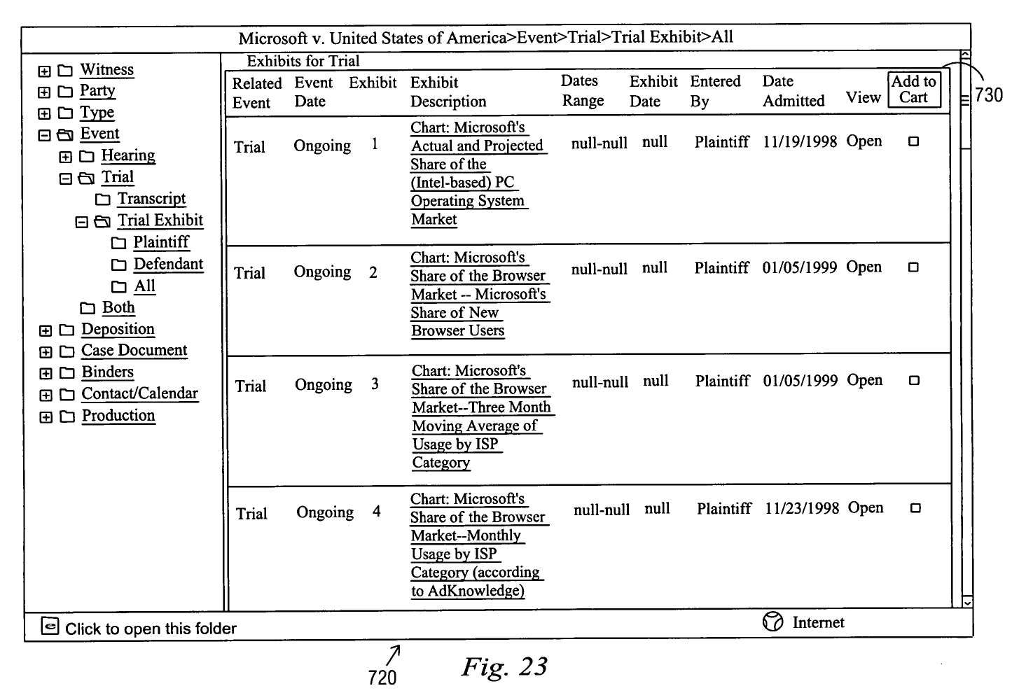

FIG. 23 depicts an all subfolder of a trial exhibit subfolder of a trial subfolder of the event folder comprising coded metadata header of a GUI in accordance with an exemplary embodiment of the present invention.

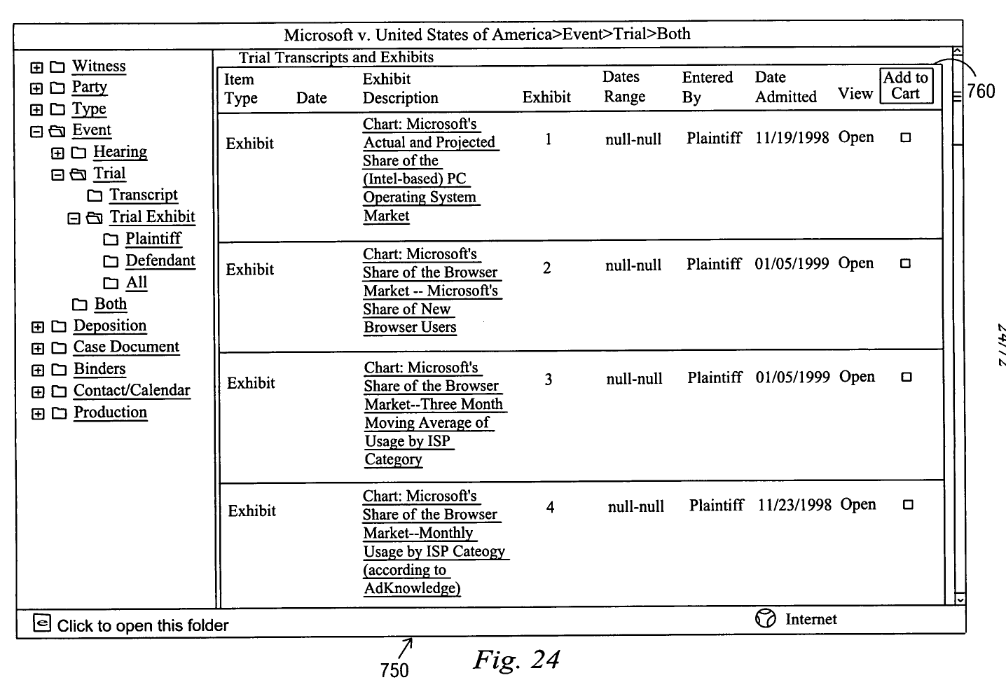

FIG. 24 depicts a both subfolder of a trial subfolder of the event folder comprising coded metadata header of a GUI in accordance with an exemplary embodiment of the present invention.

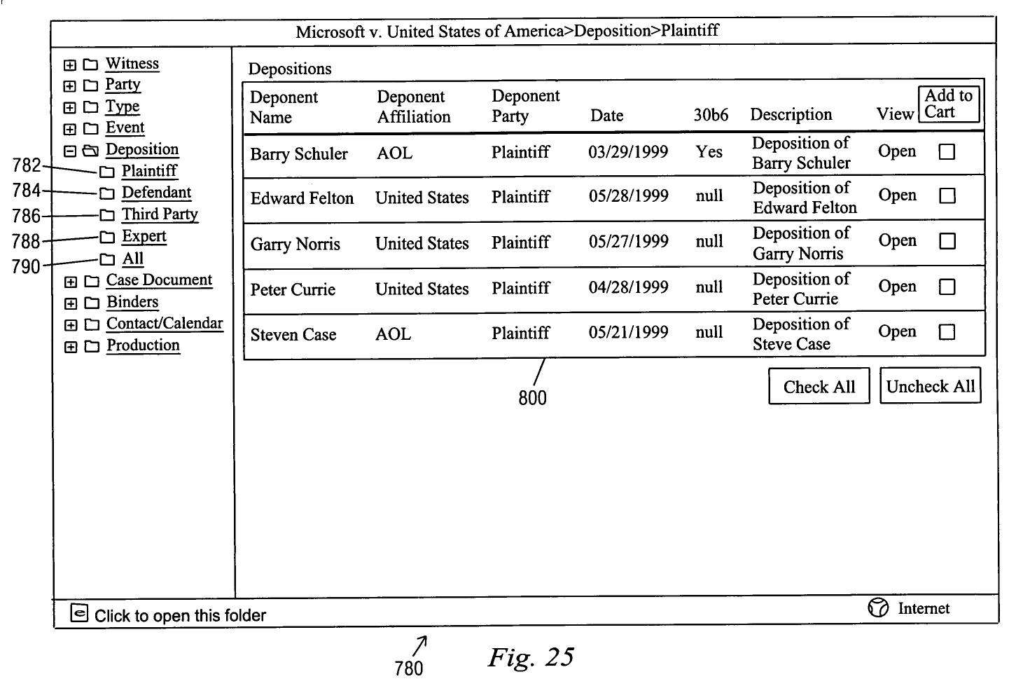

FIG. 25 depicts a deposition folder expanded with subfolders of the menu tree expanded with subfolders and a plaintiff subfolder of the deposition folder comprising coded metadata header of a GUI in accordance with an exemplary embodiment of the present invention.

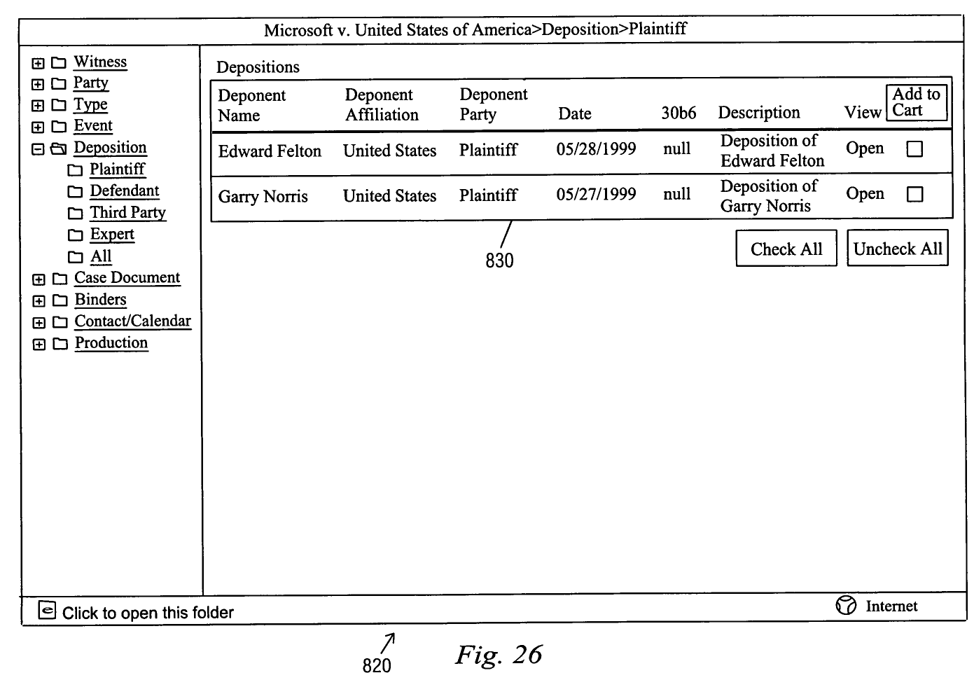

FIG. 26 depicts an expert subfolder of the deposition folder comprising coded metadata header of a GUI in accordance with an exemplary embodiment of the present invention.

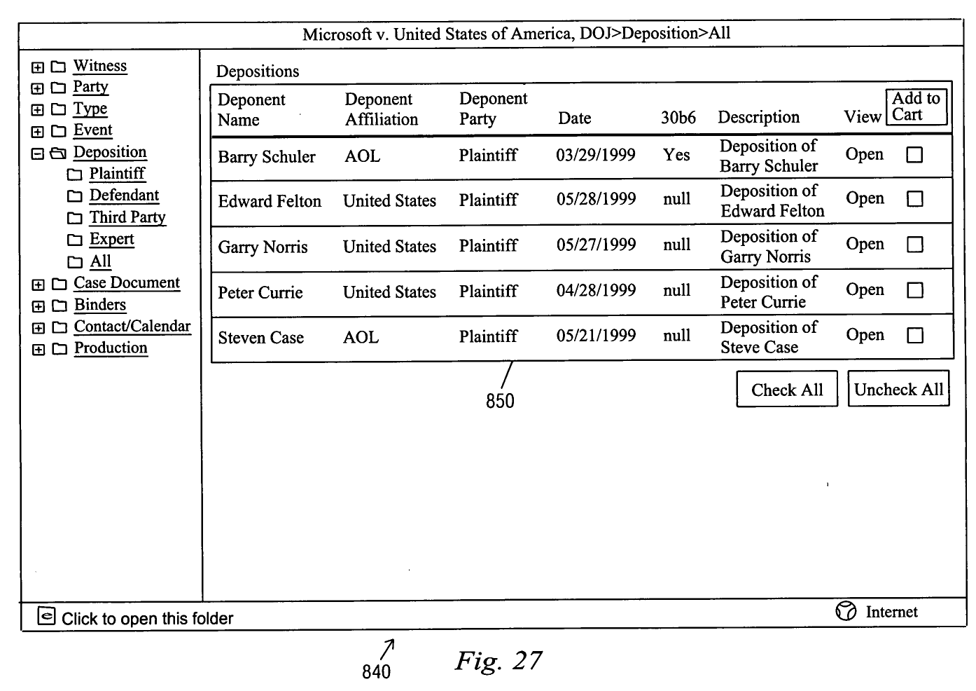

FIG. 27 depicts an all subfolder of a deposition folder comprising coded metadata header of a GUI in accordance with an exemplary embodiment of the present invention.

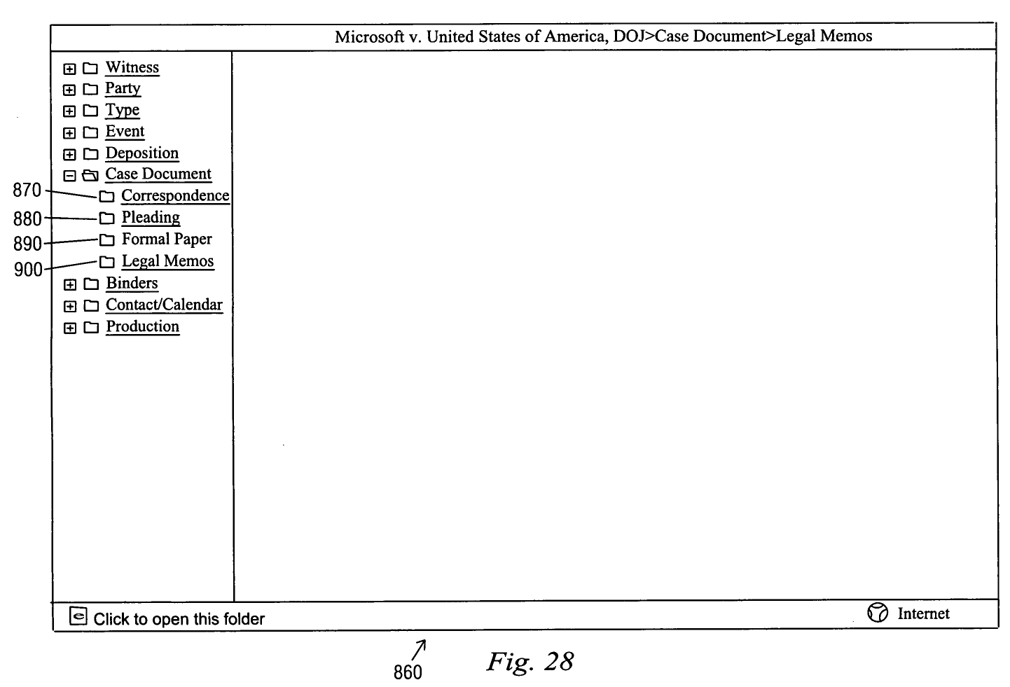

FIG. 28 depicts a case document folder of the menu tree and expanded with subfolders of a GUI in accordance with an exemplary embodiment of the present invention.

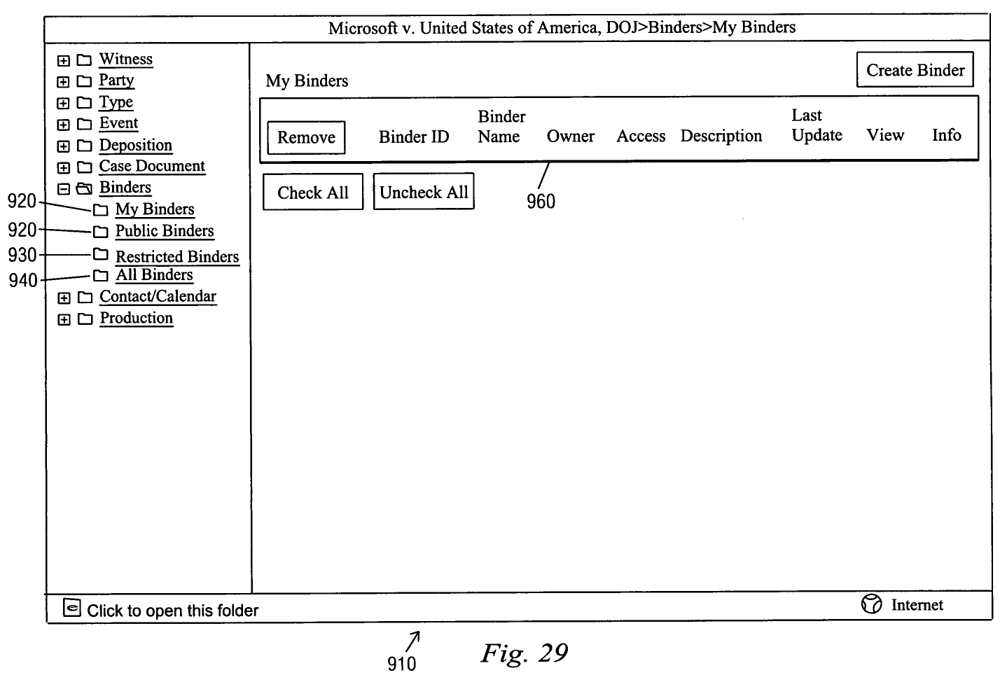

FIG. 29 depicts a binder folder of the menu tree and expanded with subfolders and my binders subfolder of the binders folder comprising coded metadata header of a GUI in accordance with an exemplary embodiment of the present invention.

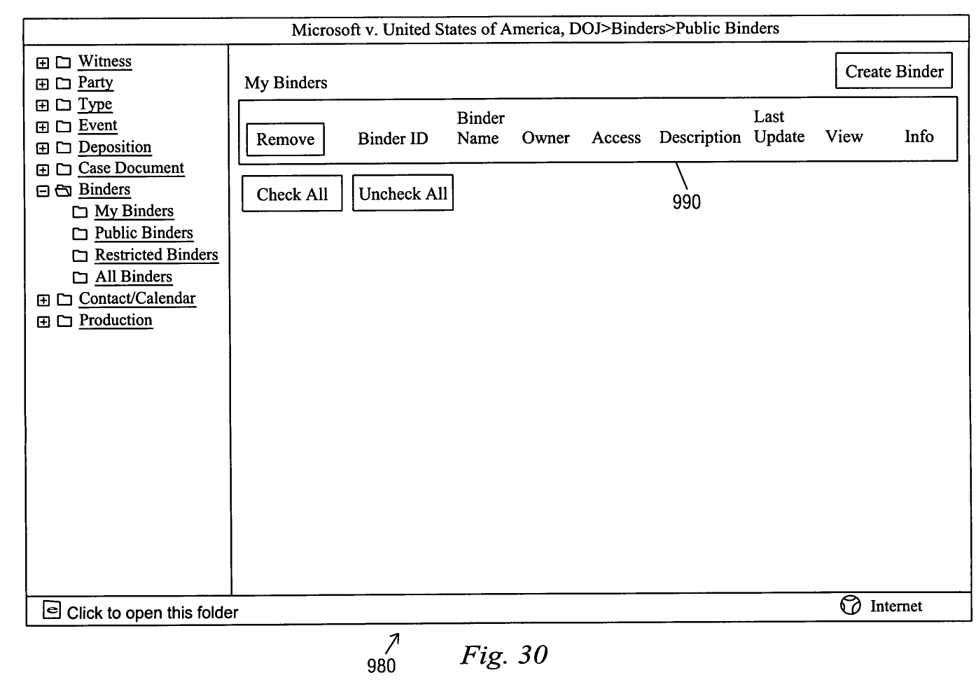

FIG. 30 depicts a public binders subfolder of the binders folder comprising coded metadata header of a GUI in accordance with an exemplary embodiment of the present invention.

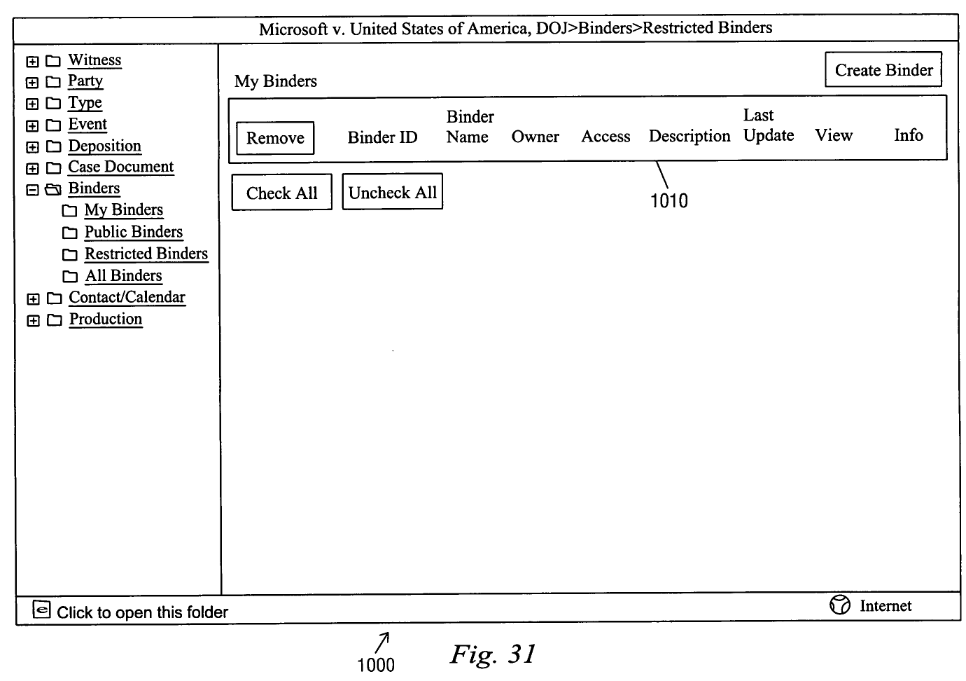

FIG. 31 depicts a restricted binders subfolder of the binders folder comprising coded metadata header of a GUI in accordance with an exemplary embodiment of the present invention.

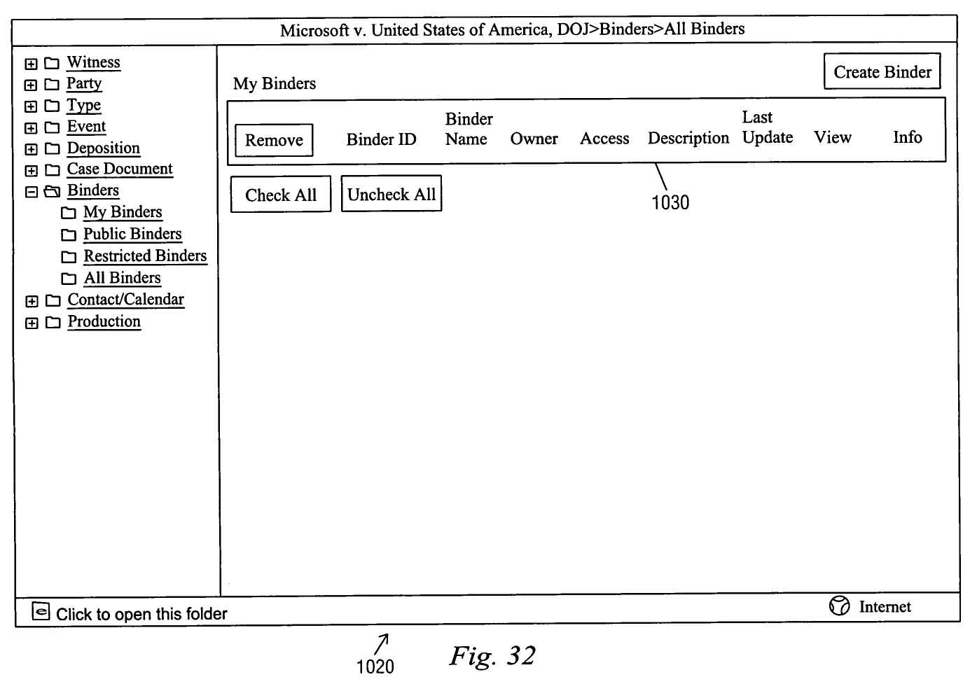

FIG. 32 depicts an all binders subfolder of the binders folder comprising coded metadata header of a GUI in accordance with an exemplary embodiment of the present invention.

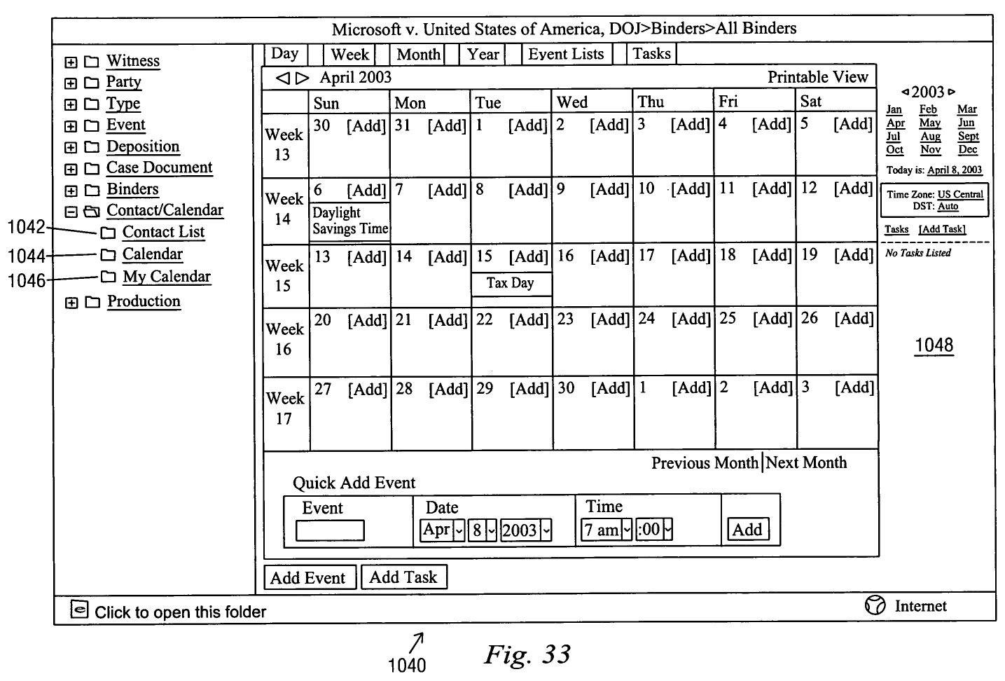

FIG. 33 depicts a contacts/calendar folder of the menu tree expanded with subfolders and a calendar subfolder of the contacts/calendar folder with calendar features of a GUI in accordance with an exemplary embodiment of the present invention.

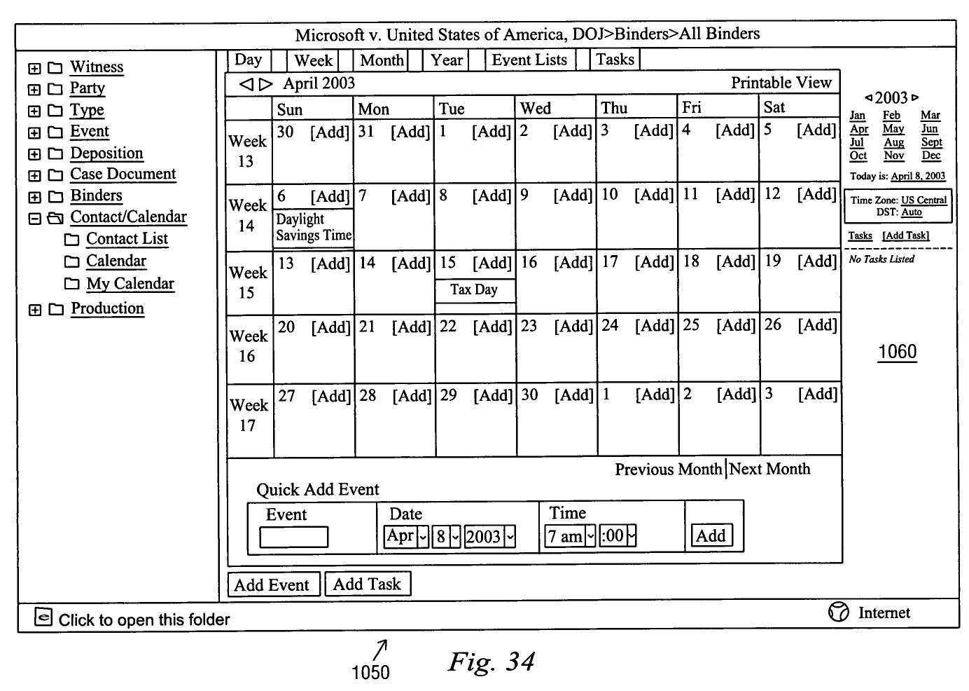

FIG. 34 depicts a my calendar subfolder of the contacts/calendar folder with calendar features of a GUI in accordance with an exemplary embodiment of the present invention.

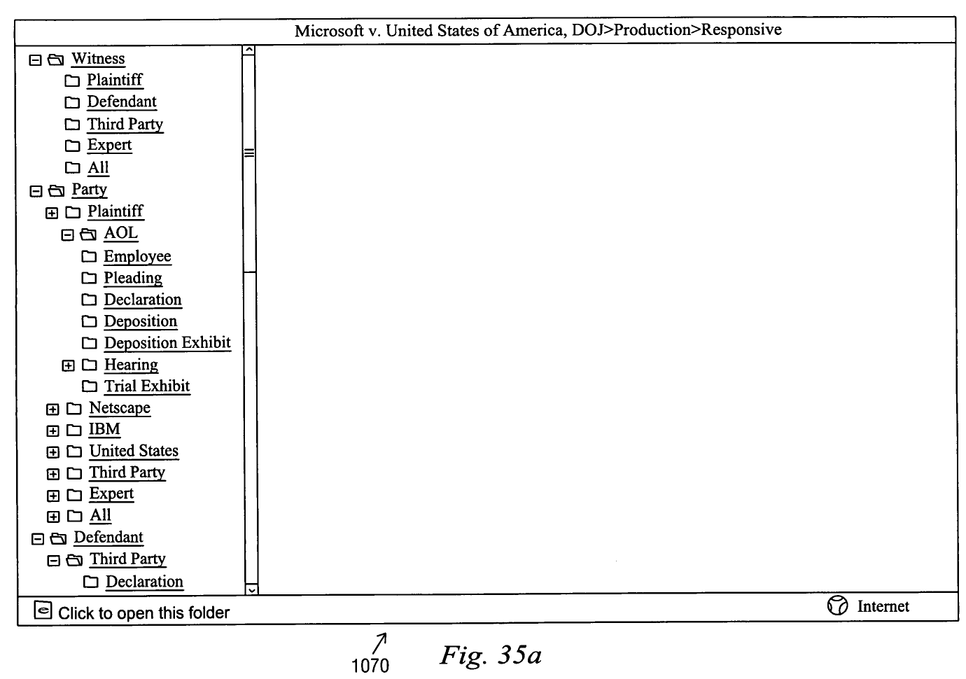

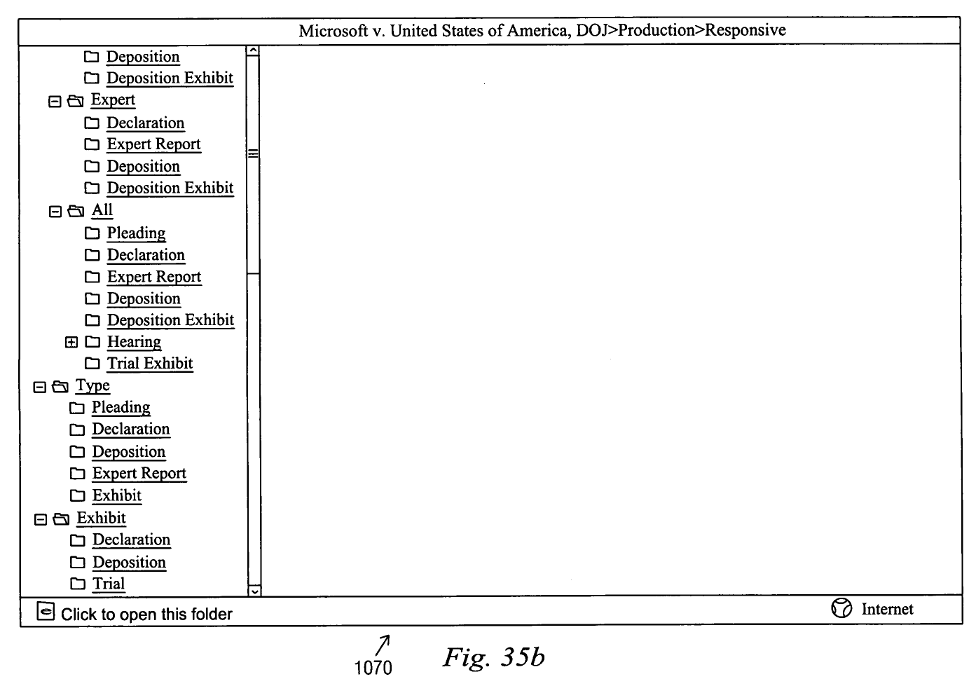

FIG. 35 depicts a menu tree expanded of a GUI in accordance with an exemplary embodiment of the present invention.

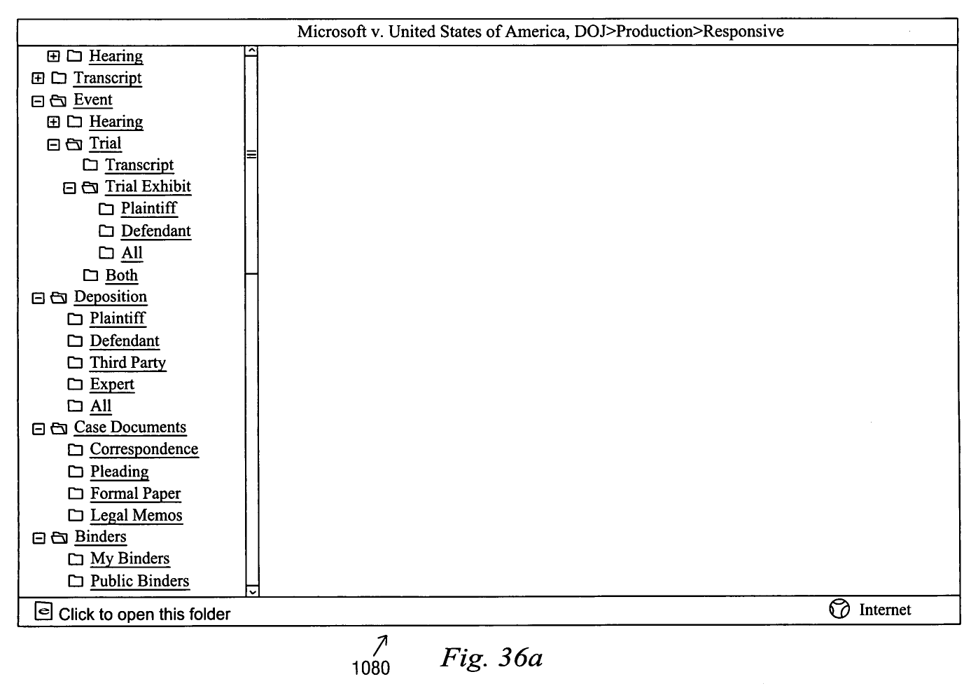

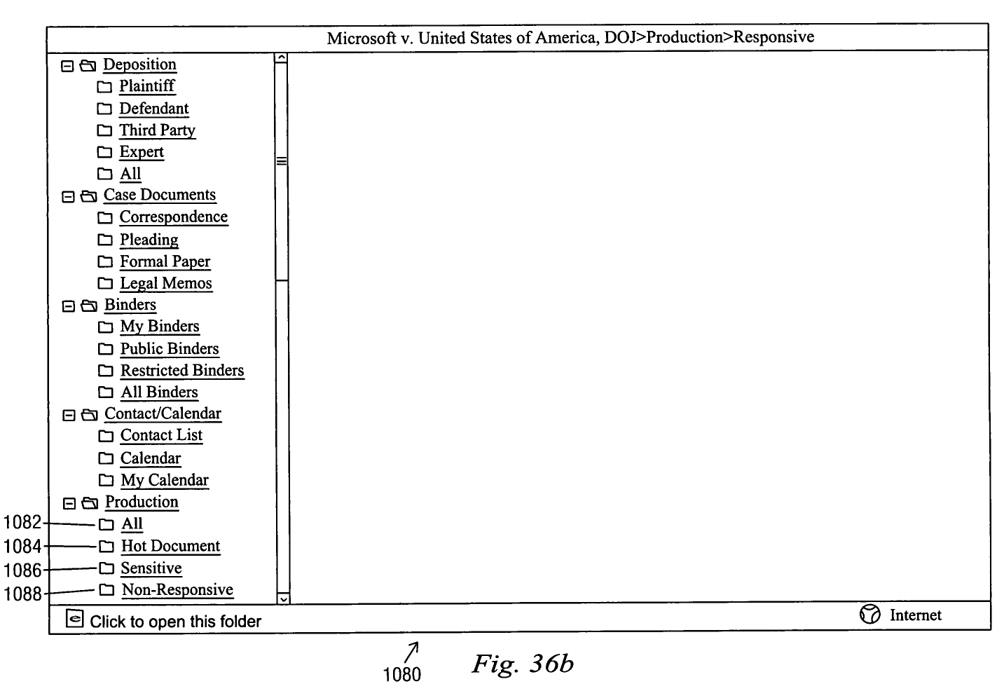

FIG. 36 depicts a menu tree expanded (con't) of a GUI in accordance with an exemplary embodiment of the present invention.

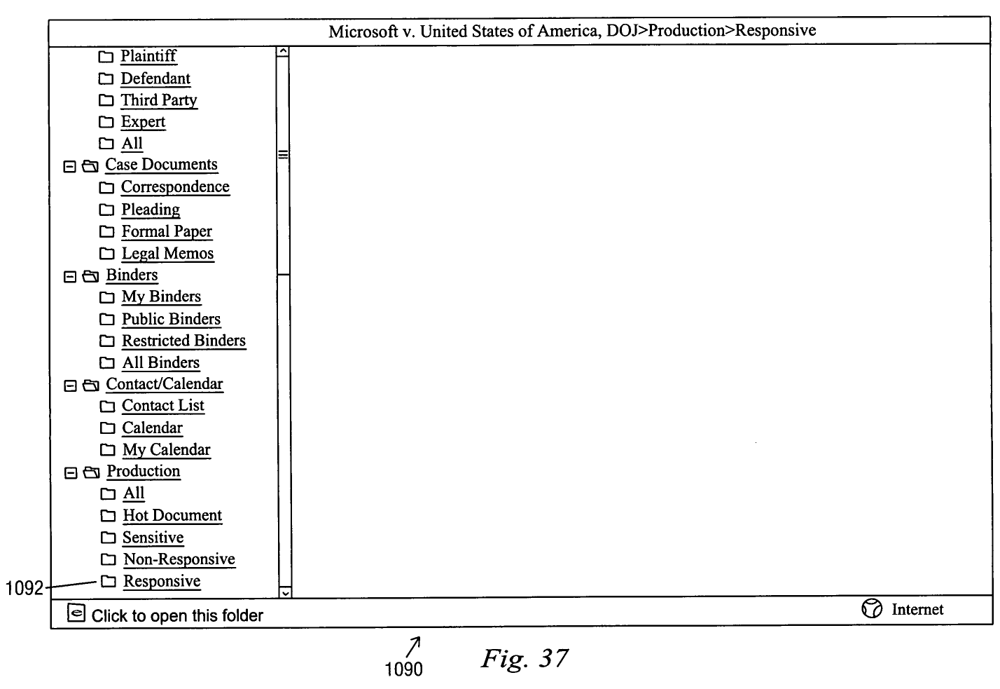

FIG. 37 depicts a menu tree expanded (con't) of a GUI in accordance with an exemplary embodiment of the present invention.

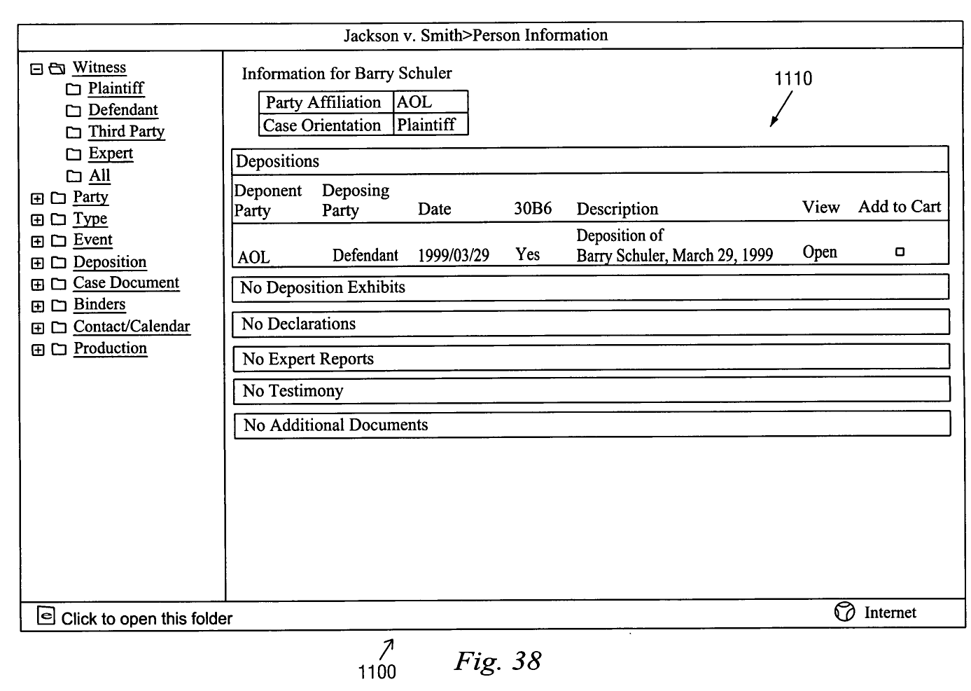

FIG. 38 depicts a subfolder of the witness folder comprising organization and coded metadata header of a GUI in accordance with an exemplary embodiment of the present invention.

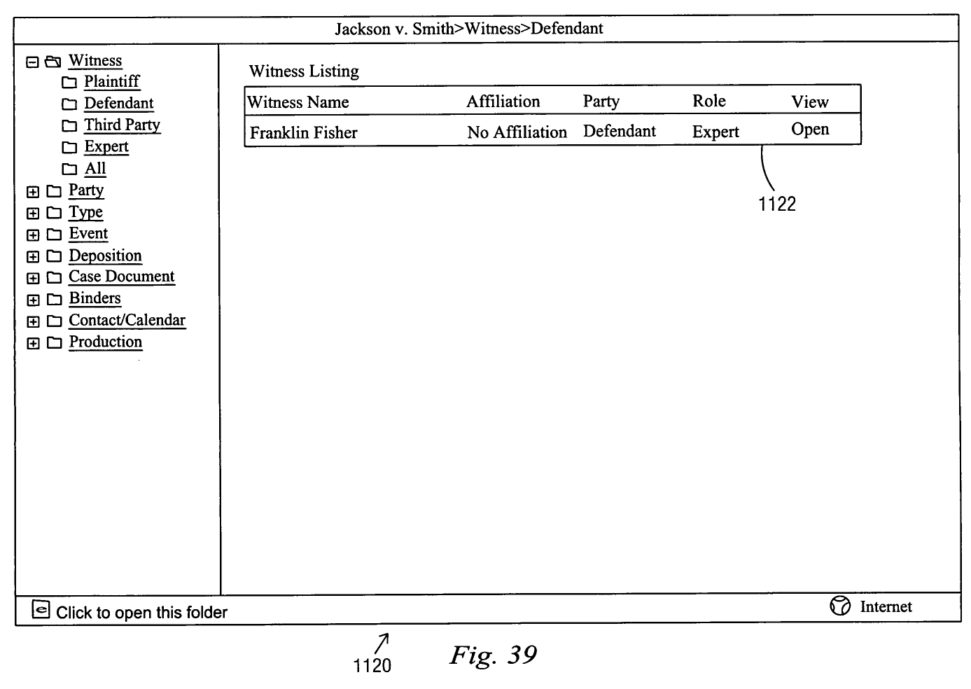

FIG. 39 depicts a defendant subfolder of the witness folder comprising coded metadata header of a GUI in accordance with an exemplary embodiment of the present invention.

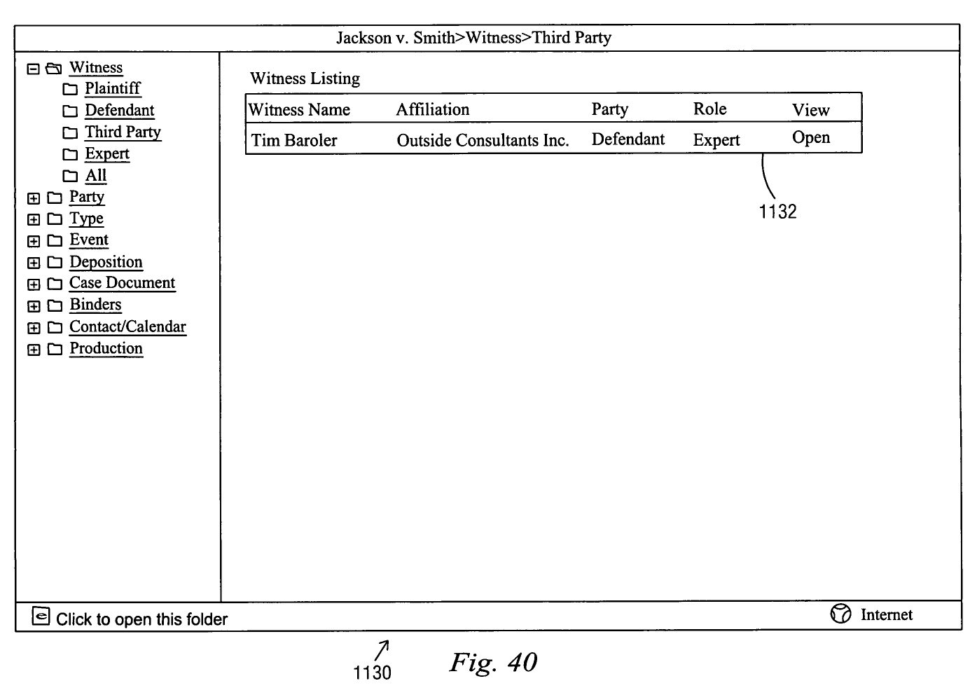

FIG. 40 depicts a third party subfolder of the witness folder comprising coded metadata header of a GUI in accordance with an exemplary embodiment of the present invention.

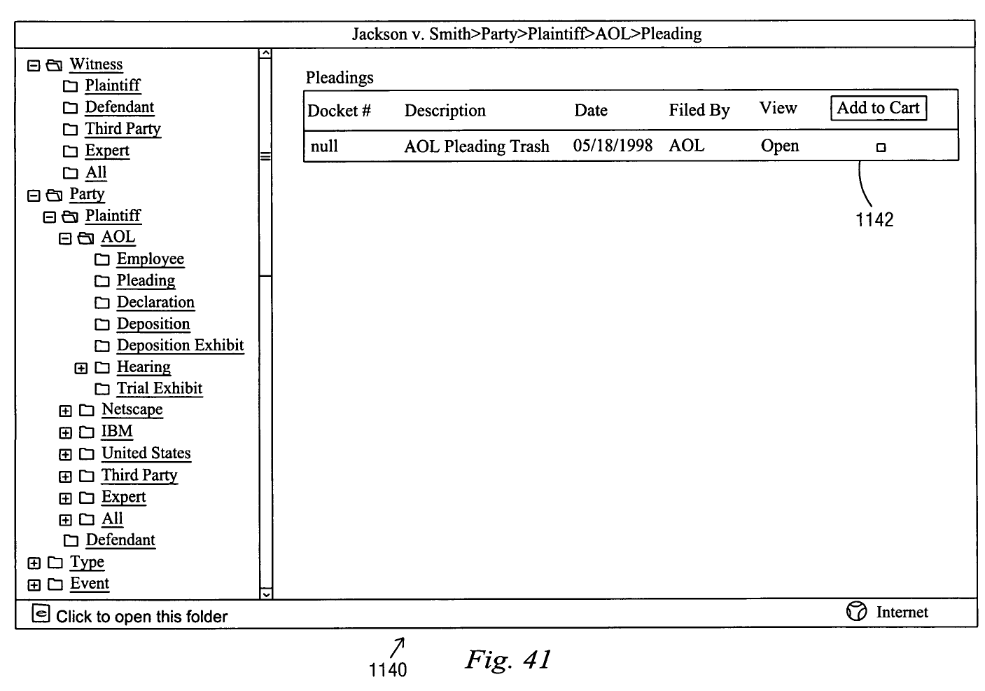

FIG. 41 depicts a pleading subfolder of a subfolder subfolder of a plaintiff subfolder of the party folder comprising coded metadata header of a GUI in accordance with an exemplary embodiment of the present invention.

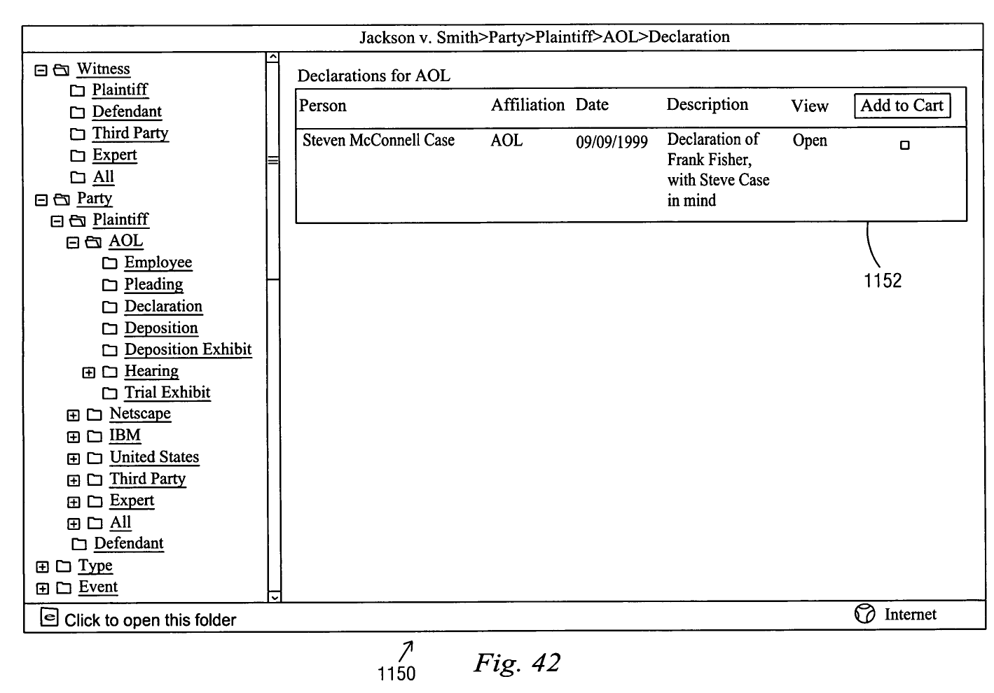

FIG. 42 depicts a declaration subfolder of a subfolder subfolder of a plaintiff subfolder of the party folder comprising coded metadata header of a GUI in accordance with an exemplary embodiment of the present invention.

FIG. 43 depicts a deposition exhibit subfolder of a subfolder subfolder of a plaintiff subfolder of the party folder comprising coded metadata header of a GUI in accordance with an exemplary embodiment of the present invention.

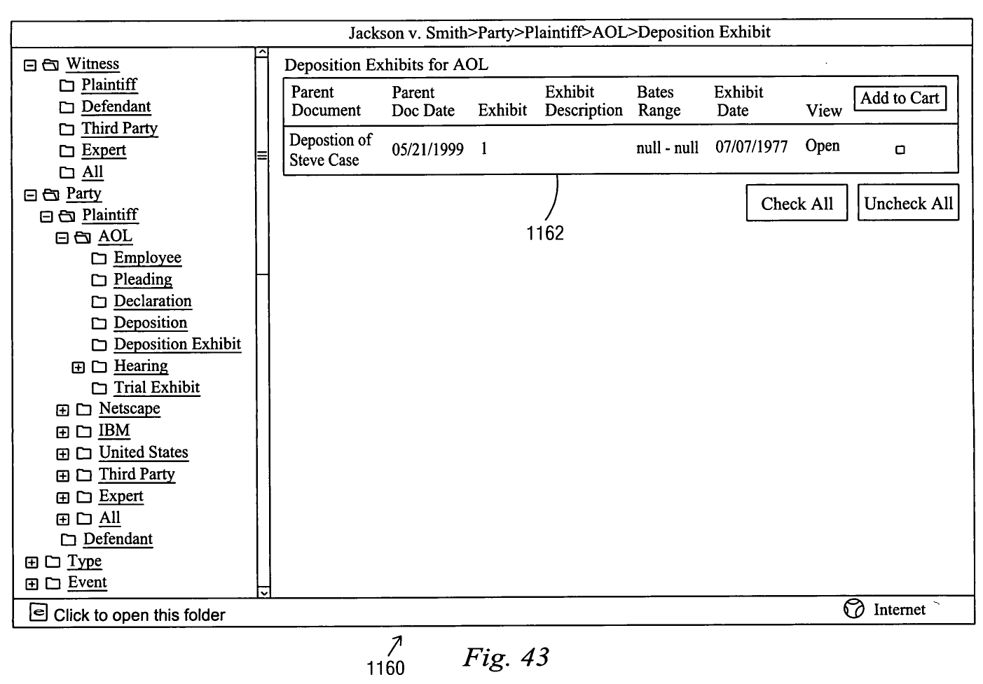

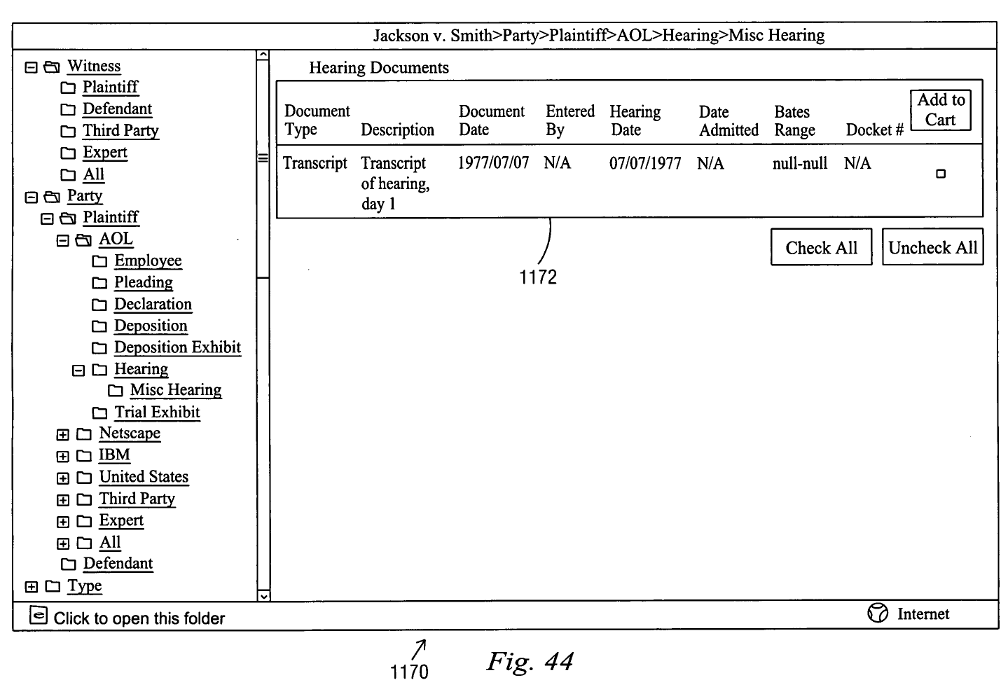

FIG. 44 depicts a hearing subfolder of a subfolder subfolder of a plaintiff subfolder of the party folder comprising coded metadata header of a GUI in accordance with an exemplary embodiment of the present invention.

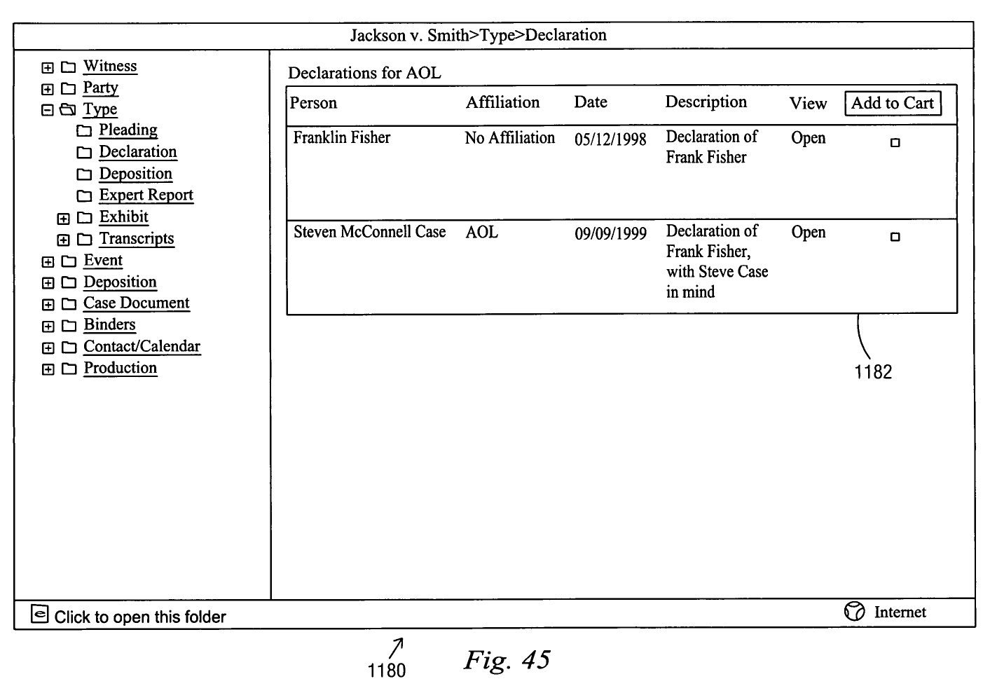

FIG. 45 depicts a declaration subfolder of the type folder comprising coded metadata header of a GUI in accordance with an exemplary embodiment of the present invention.

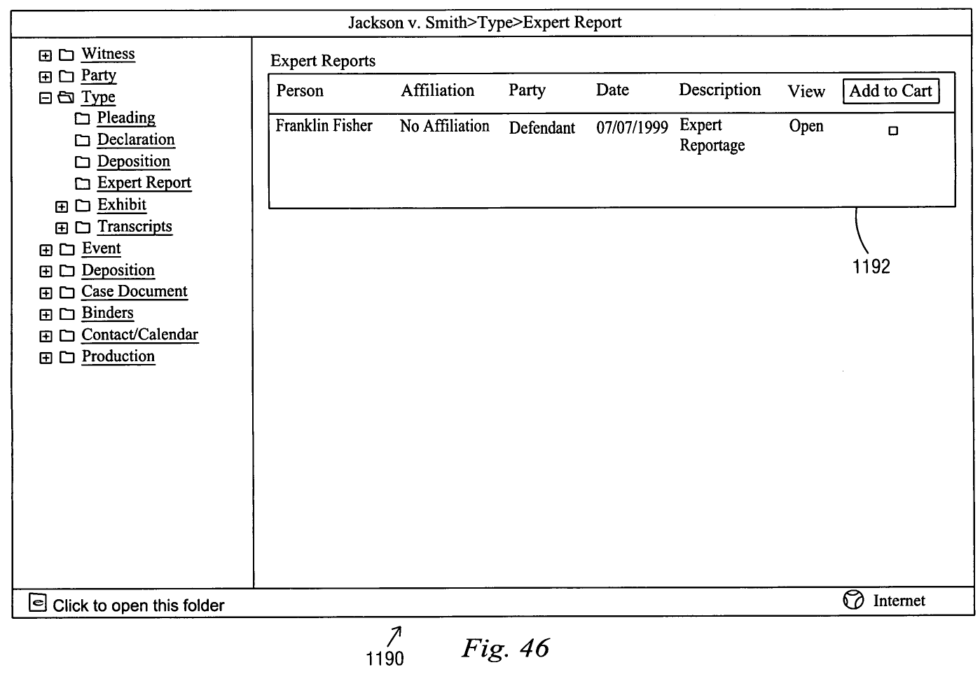

FIG. 46 depicts an expert report subfolder of the type folder comprising coded metadata header of a GUI in accordance with an exemplary embodiment of the present invention.

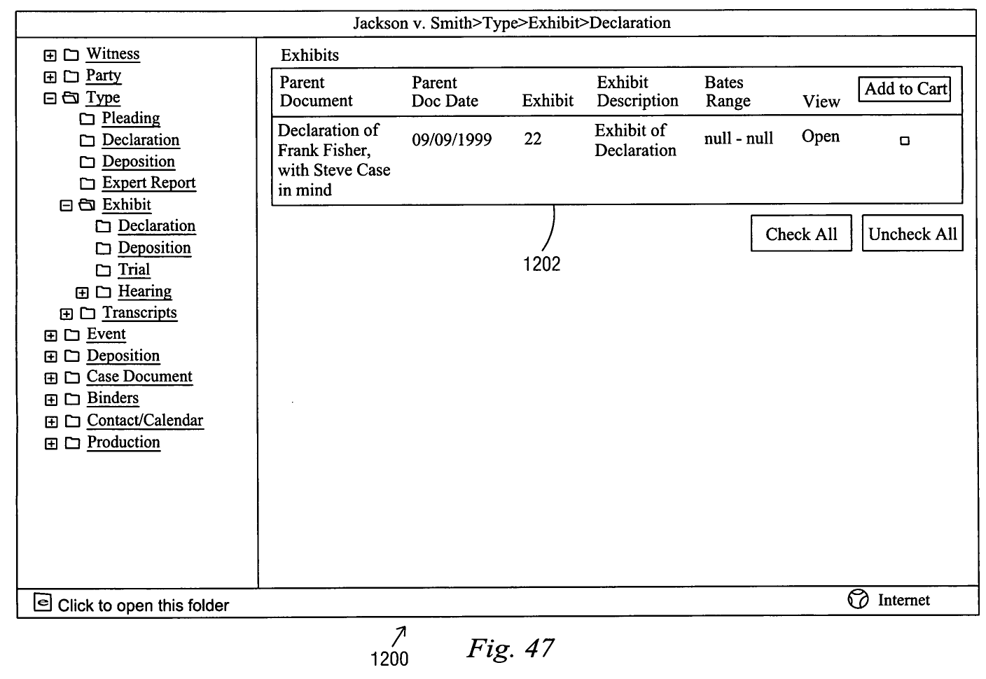

FIG. 47 depicts a declaration subfolder of an exhibit subfolder of the type folder comprising coded metadata header of a GUI in accordance with an exemplary embodiment of the present invention.

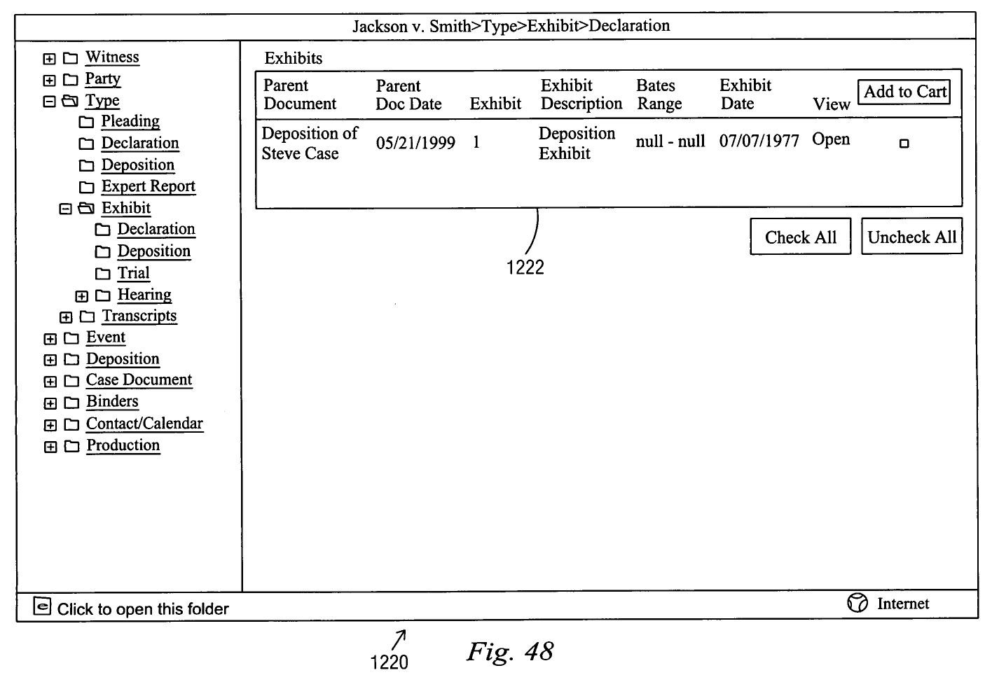

FIG. 48 depicts a deposition subfolder of an exhibit subfolder of the type folder comprising coded metadata header of a GUI in accordance with an exemplary embodiment of the present invention.

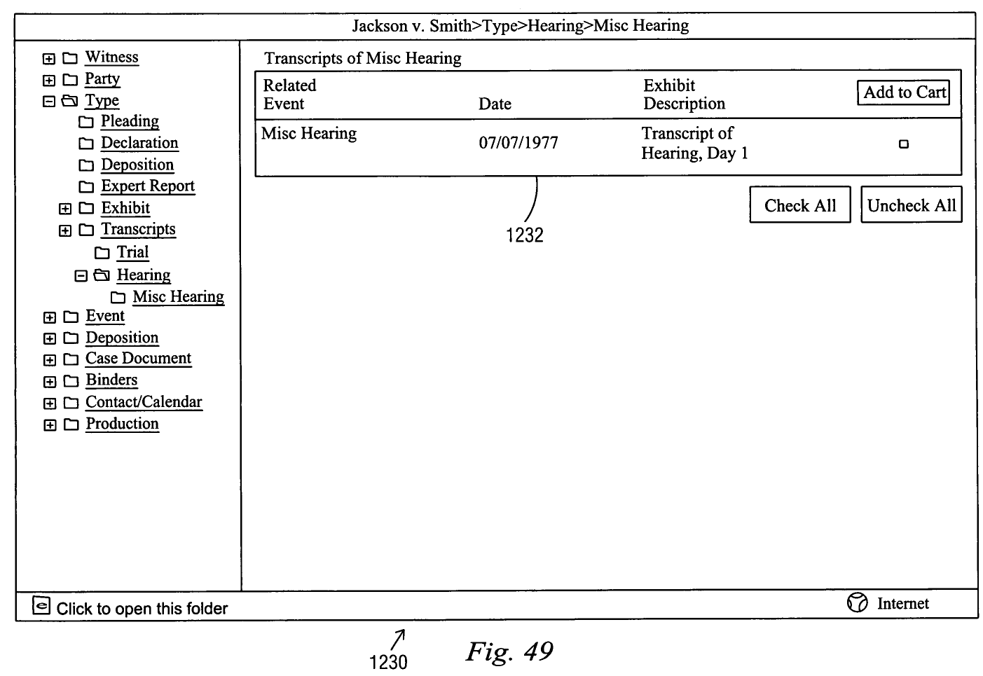

FIG. 49 depicts a folder subfolder of a hearing subfolder of the type folder and a subfolder subfolder of a folder subfolder of a hearing subfolder of the type folder comprising coded metadata header of a GUI in accordance with an exemplary embodiment of the present invention.

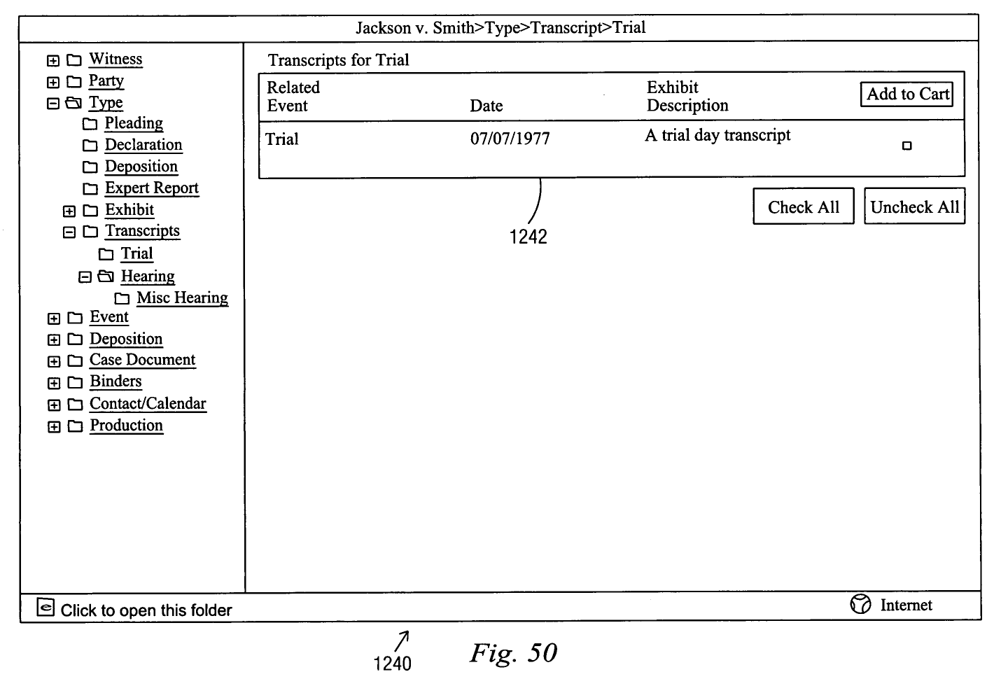

FIG. 50 depicts a trial subfolder of a transcript subfolder of the type folder comprising coded metadata header of a GUI in accordance with an exemplary embodiment of the present invention.

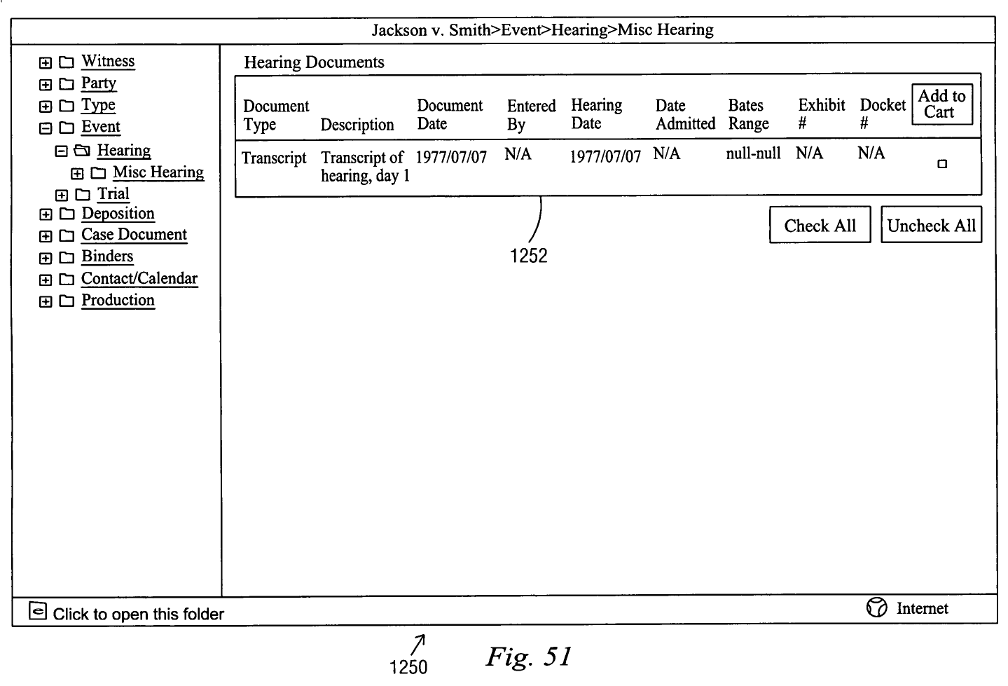

FIG. 51 depicts a hearing subfolder of the event folder comprising coded metadata header of a GUI in accordance with an exemplary embodiment of the present invention.

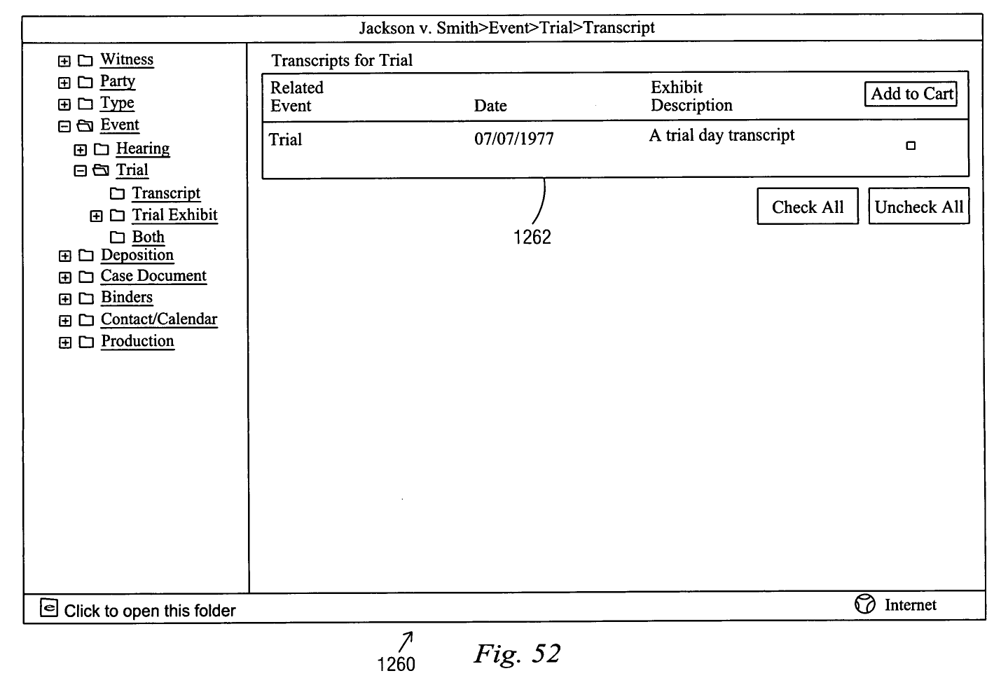

FIG. 52 comprises a transcript subfolder of a trial subfolder of the event folder comprising coded metadata header of a GUI in accordance with an exemplary embodiment of the present invention;

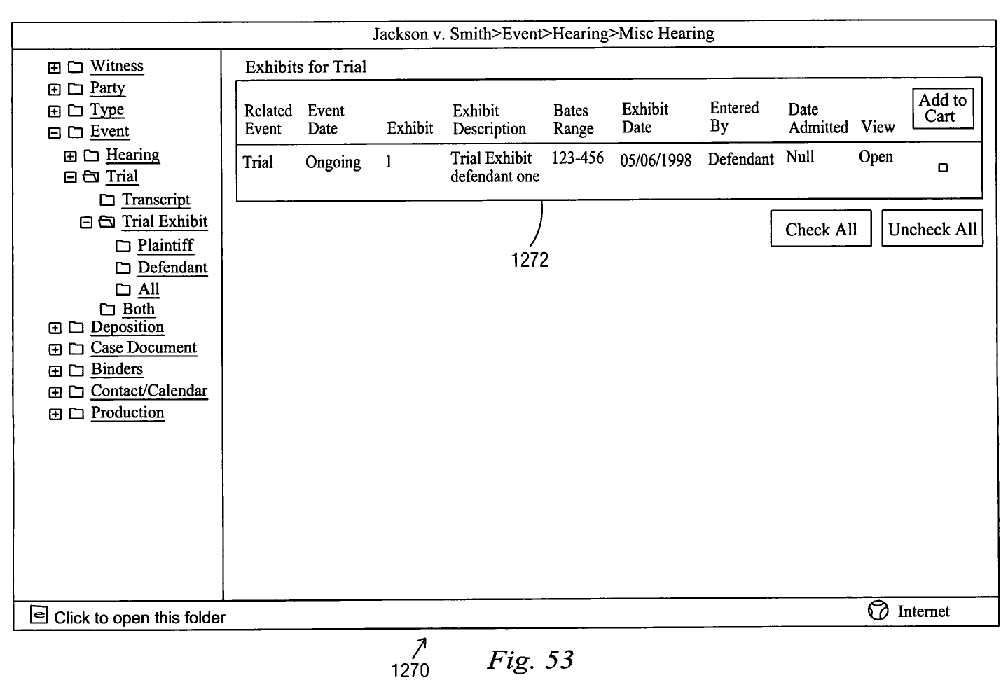

FIG. 53 depicts a subfolder subfolder of a trial exhibit subfolder of the trial folder comprising coded metadata header of a GUI in accordance with an exemplary embodiment of the present invention.

FIG. 54 depicts a defendant subfolder of the deposition folder comprising coded metadata header of a GUI in accordance with an exemplary embodiment of the present invention.

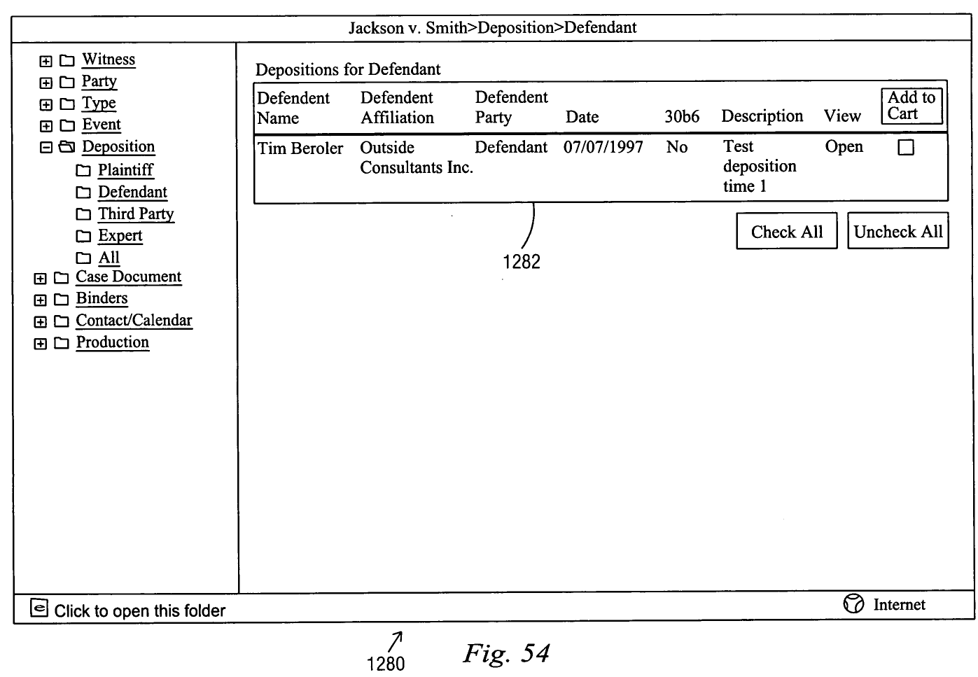

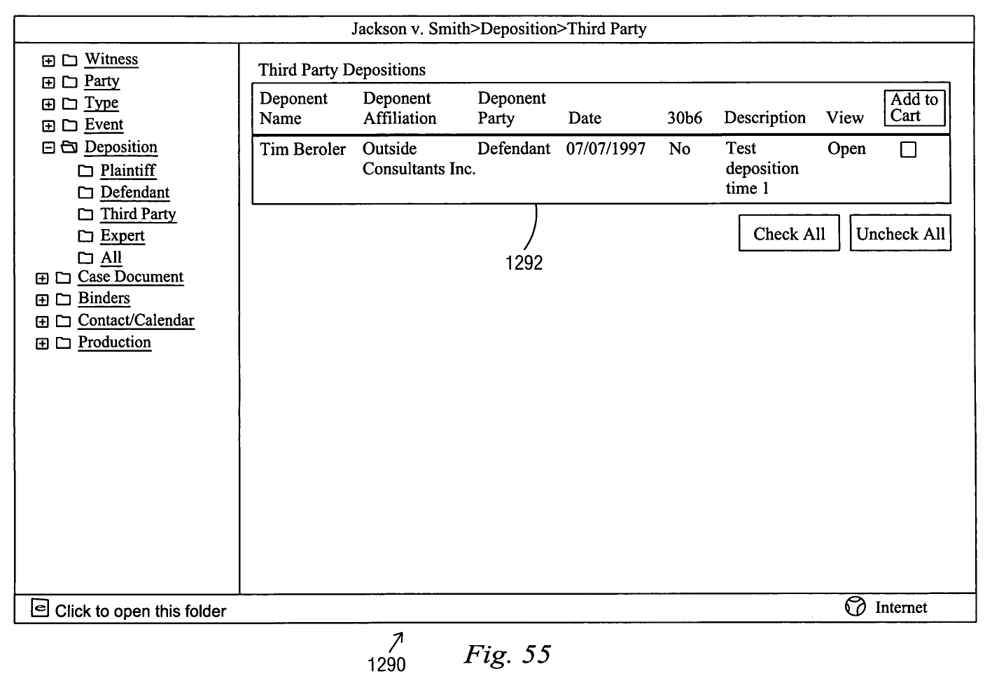

FIG. 55 depicts a third party subfolder of the deposition folder comprising coded metadata header of a GUI in accordance with an exemplary embodiment of the present invention.

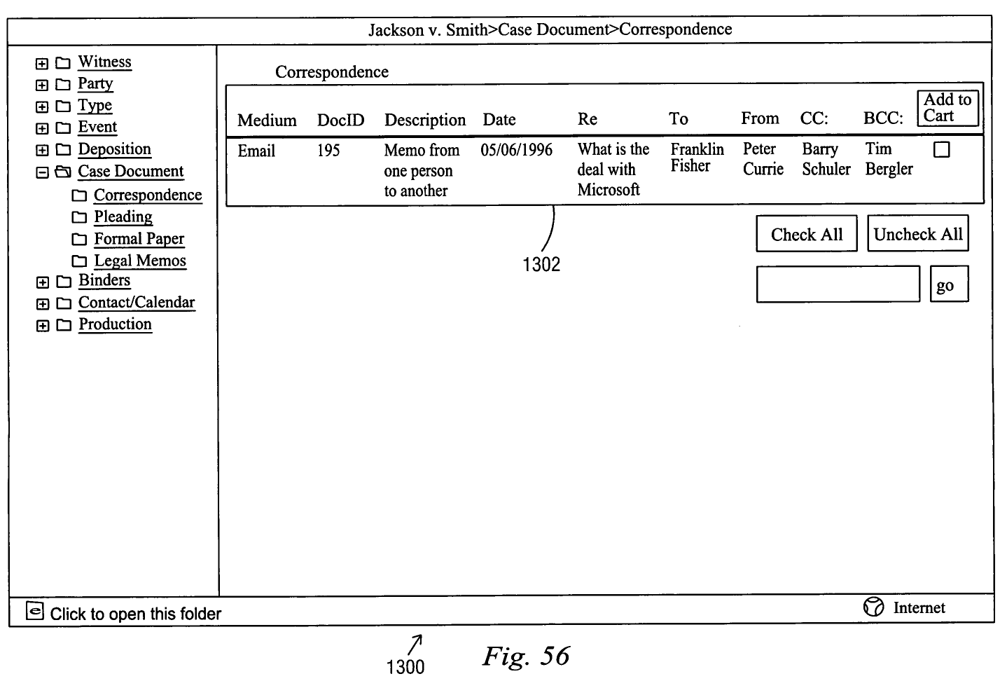

FIG. 56 depicts a correspondence subfolder of the case document folder comprising coded metadata header of a GUI in accordance with an exemplary embodiment of the present invention.

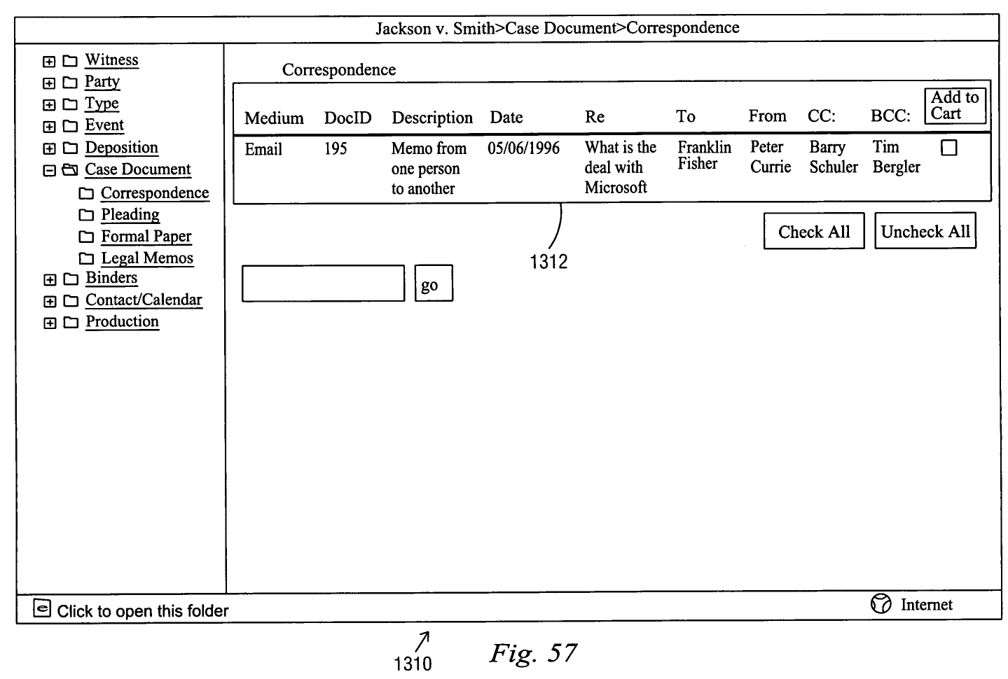

FIG. 57 depicts a correspondence subfolder of the case document folder comprising coded metadata header of a GUI in accordance with an exemplary embodiment of the present invention.

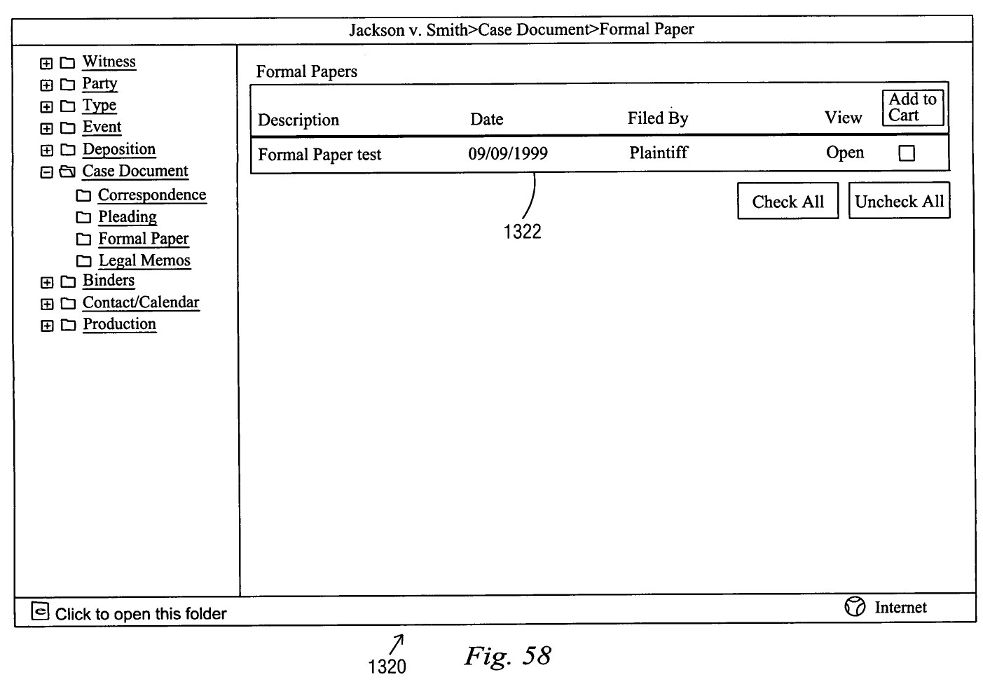

FIG. 58 depicts a formal paper subfolder of the case document folder comprising coded metadata header of a GUI in accordance with an exemplary embodiment of the present invention.

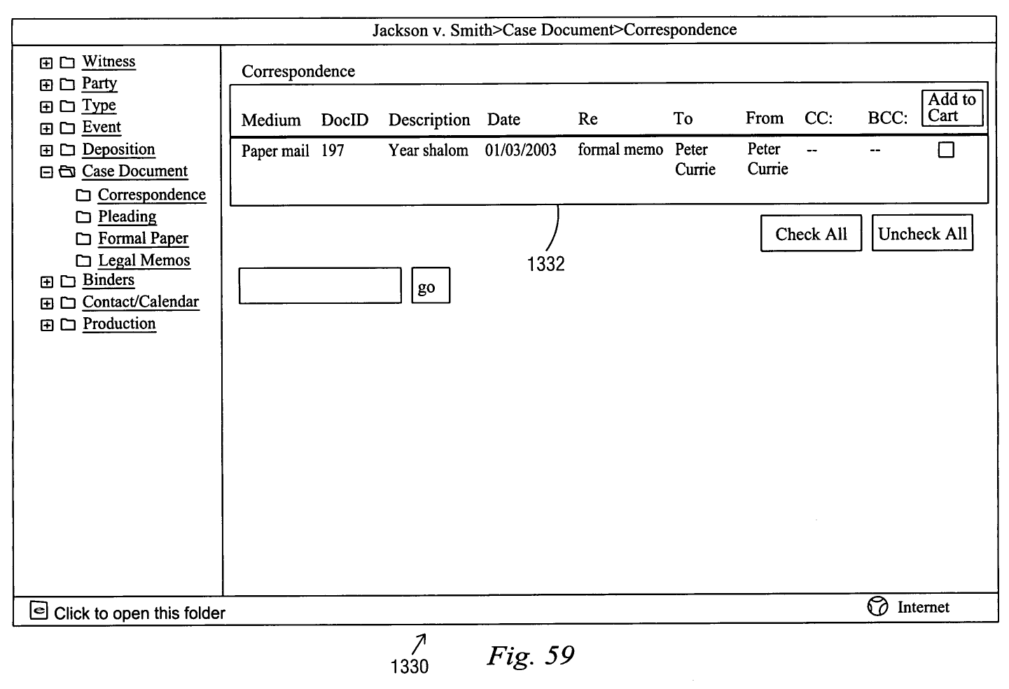

FIG. 59 depicts a legal memos subfolder of the case document folder comprising coded metadata header of a GUI in accordance with an exemplary embodiment of the present invention.

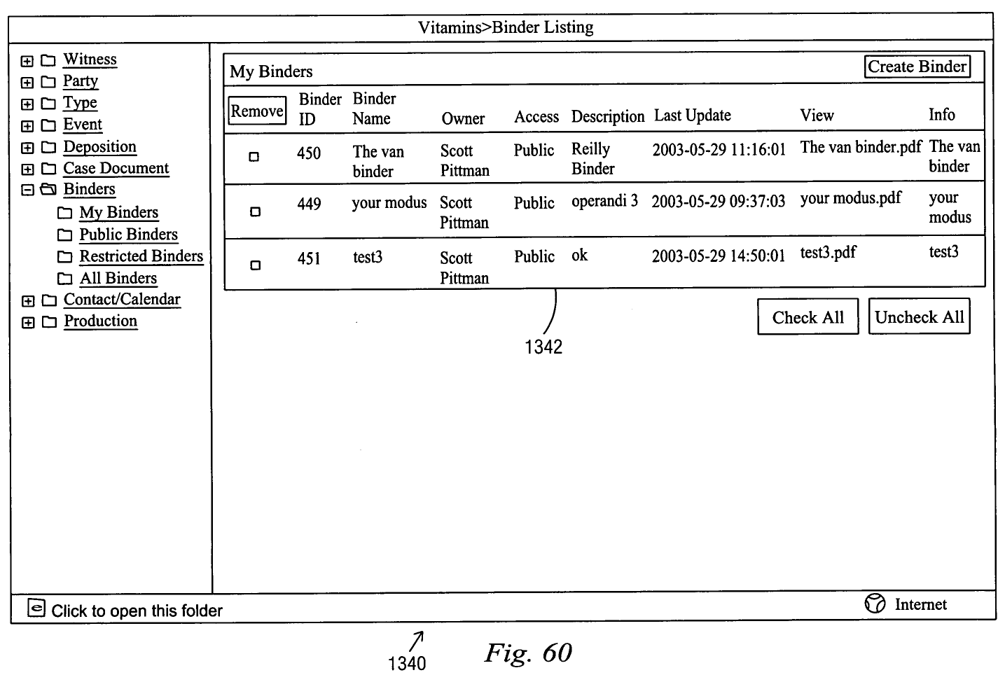

FIG. 60 depicts a my binders subfolder of the binders folder comprising coded metadata header of a GUI in accordance with an exemplary embodiment of the present invention.

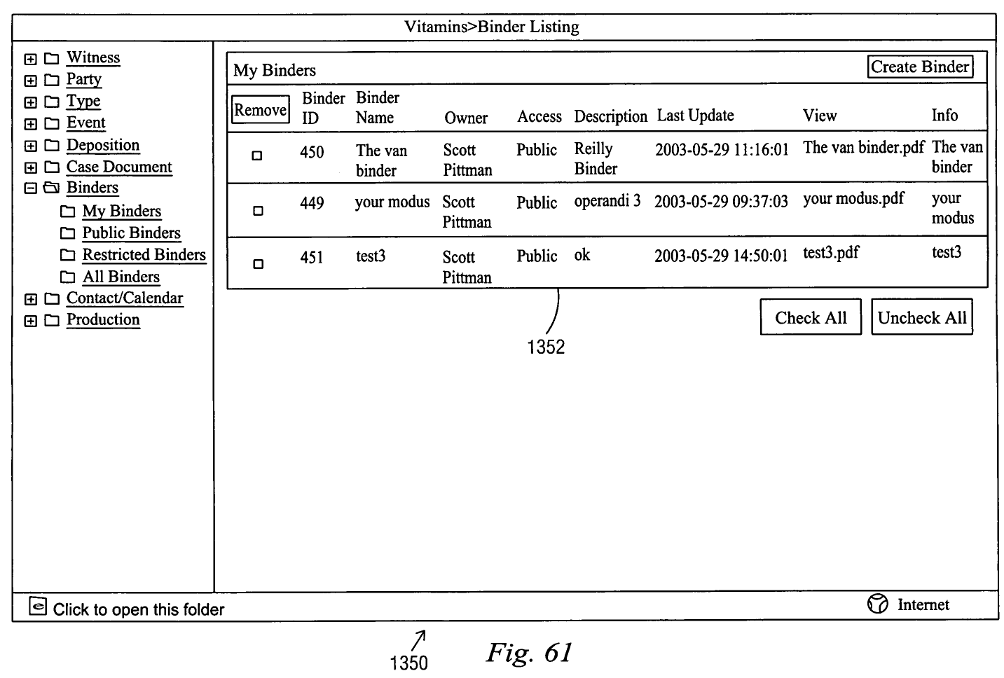

FIG. 61 depicts a public binders subfolder of the binders folder comprising coded metadata header of a GUI in accordance with an exemplary embodiment of the present invention.

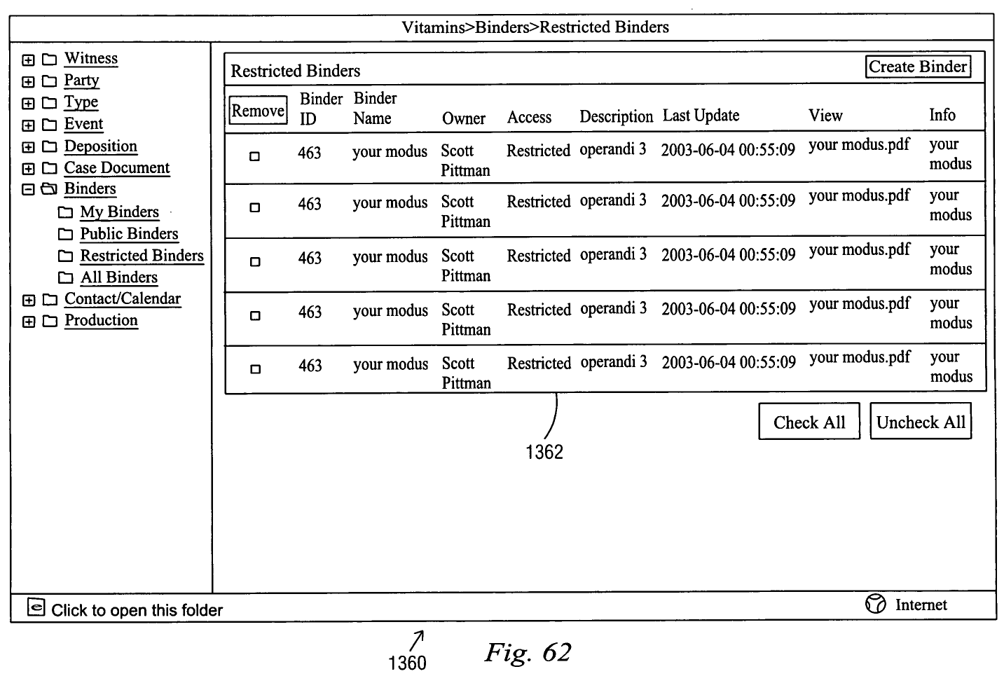

FIG. 62 depicts a restricted binders subfolder of the binders folder comprising coded metadata header of a GUI in accordance with an exemplary embodiment of the present invention.

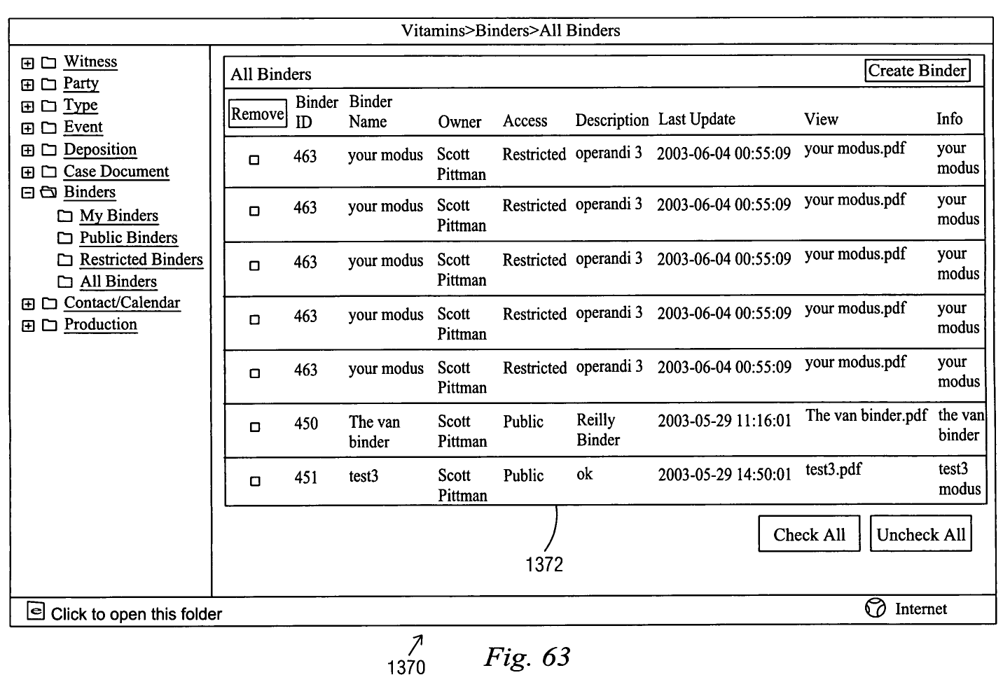

FIG. 63 depicts an all binders subfolder of the binders folder comprising coded metadata header of a GUI in accordance with an exemplary embodiment of the present invention.

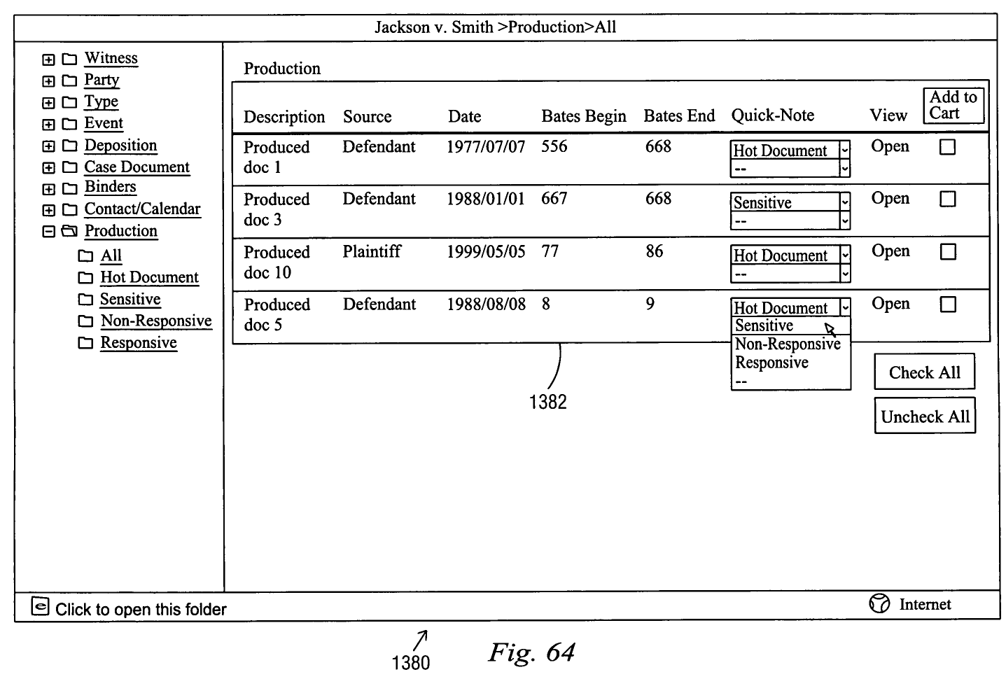

FIG. 64 depicts an all subfolder of the production folder comprising coded metadata header and features of a GUI in accordance with an exemplary embodiment of the present invention.

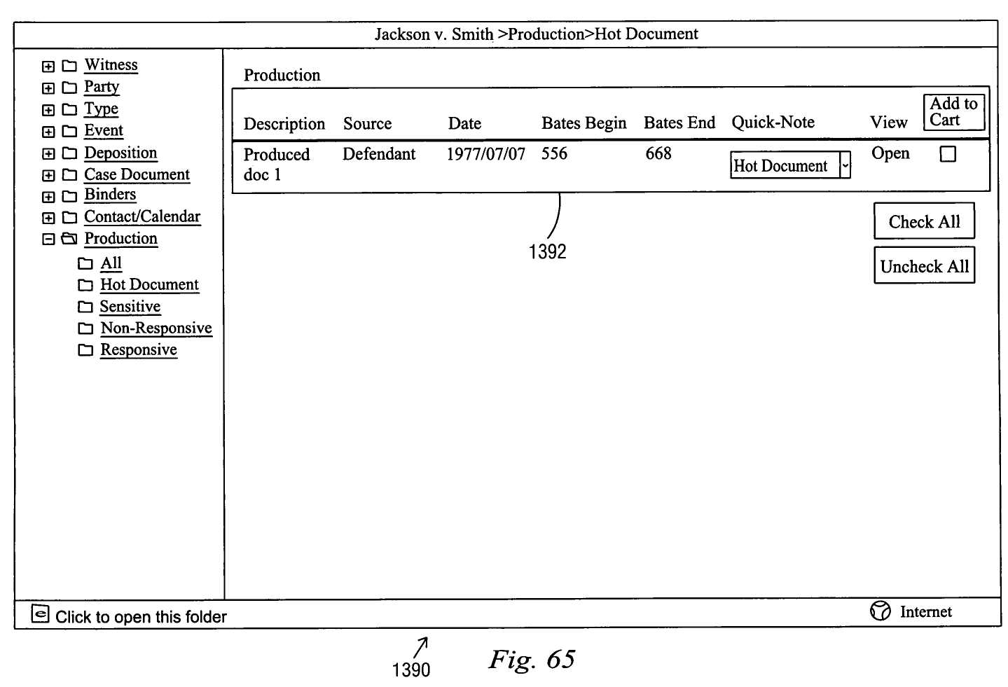

FIG. 65 depicts a hot document subfolder of the production folder comprising coded metadata header and features of a GUI in accordance with an exemplary embodiment of the present invention.

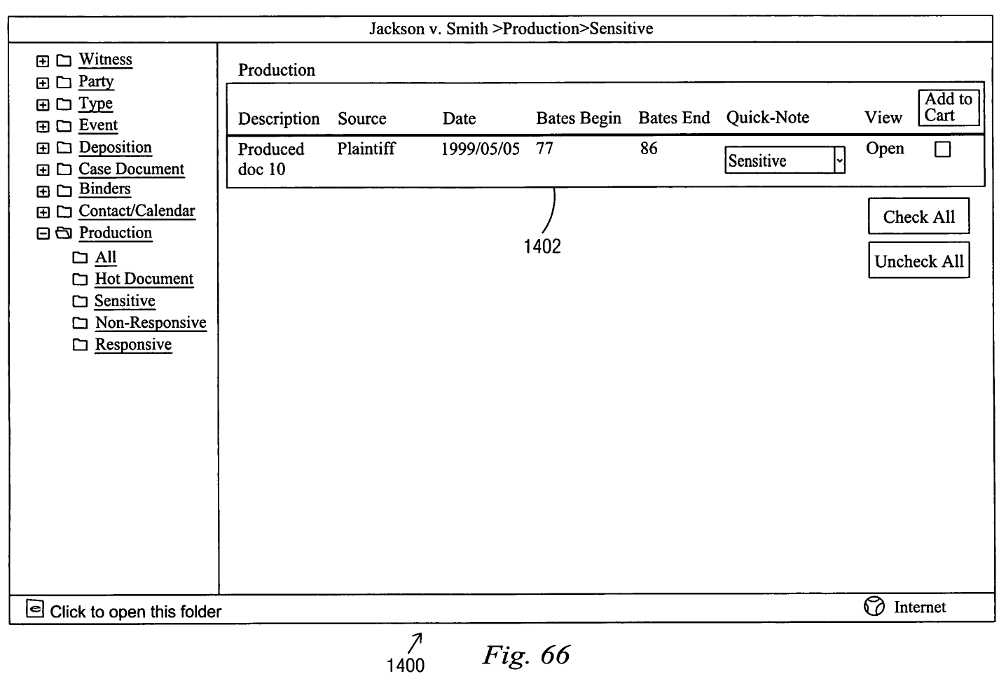

FIG. 66 depicts a sensitive subfolder of the production folder comprising coded metadata header and features of a GUI in accordance with an exemplary embodiment of the present invention.

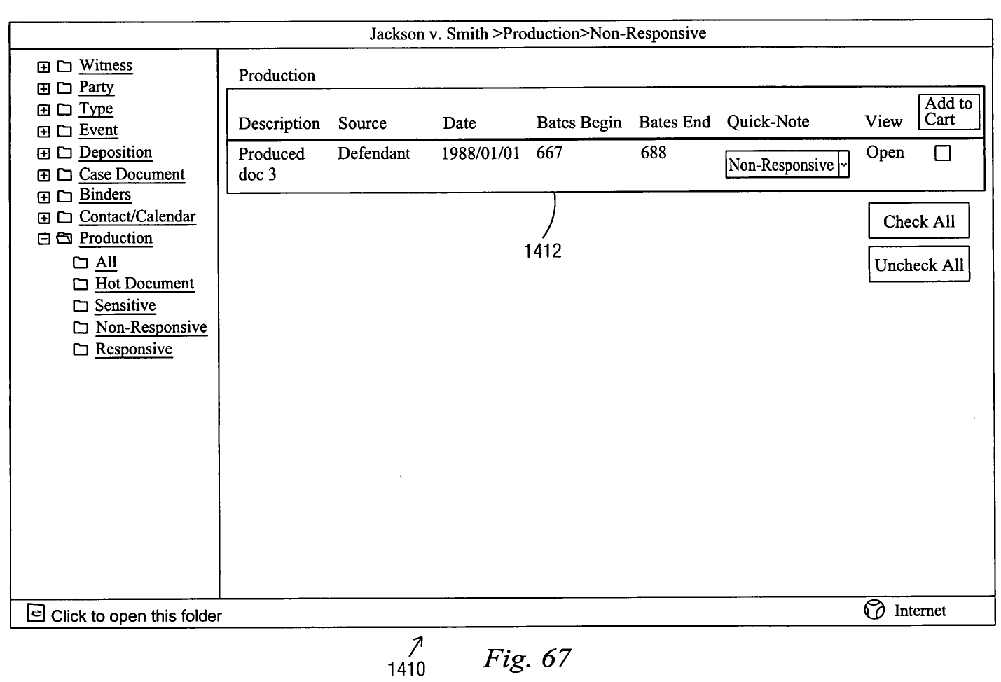

FIG. 67 depicts a non-responsive subfolder of the production folder comprising coded metadata and features of a GUI in accordance with an exemplary embodiment of the present invention.

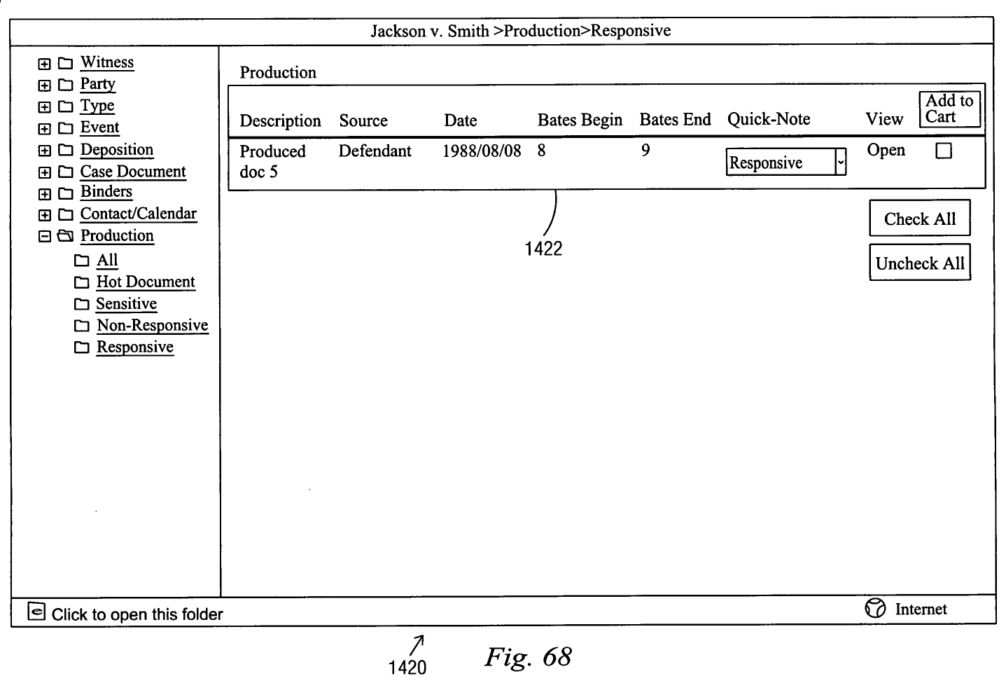

FIG. 68 depicts a responsive subfolder of the production folder comprising coded metadata header and features of a GUI in accordance with an exemplary embodiment of the present invention.

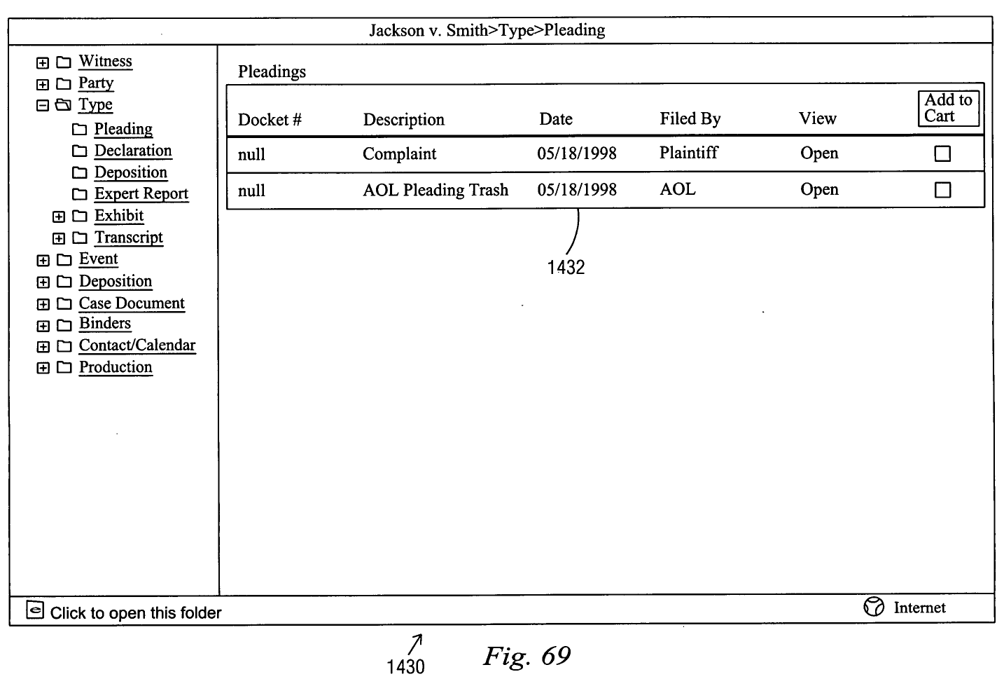

FIG. 69 depicts a pleading subfolder of the type folder comprising coded metadata header of a GUI in accordance with an exemplary embodiment of the present invention.

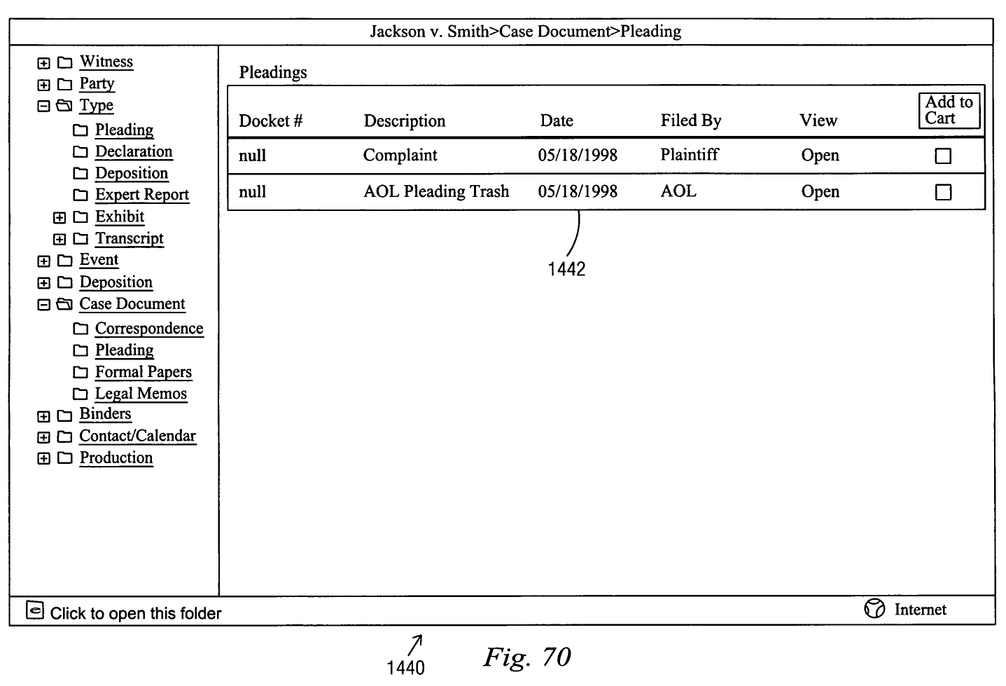

FIG. 70 depicts a pleading subfolder of the case document folder comprising coded metadata header and features of a GUI in accordance with an exemplary embodiment of the present invention.

FIG. 71 depicts a network that supports an application comprising one or more of the GUIs described in the present invention.

Although an exemplary embodiment of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

For example, the rearrangements, modifications, and substitutions include: an ability to hide the menu tree temporarily and to shrink the header section (for added visible space on the screen); enhanced search options; a “portable” version of the product (standalone application that synchronizes with what is available on the web when a connection is available); the LitCoder (used for efficient data entry that is not seen by a user); threaded notes functionality, a My Folders and Public Folders functionality (where users create their own folder structure in part of the menu tree and place copies of whatever documents they want to in those folders); and the ability for users to upload their own work product to the system.

1. A method for managing documents, comprising:
associating a first document in a first category with a second document in a second category; and
grouping the documents.

2. The method of claim 1, wherein the first document and the second document contain at least one related item.

3. The method of claim 1, wherein the first document and the second document are unrelated.

4. The method of claim 1, wherein the categories are related.

5. The method of claim 1, wherein the categories are unrelated.

6. The method of claim 1 further comprising associating a plurality of documents in a first category with a plurality of documents in a plurality of categories.

7. A computer readable medium comprising instructions for:
associating a first document in a first category with a second document in a second category;
wherein the first document and the second document have at least one related item;
wherein the categories are separate;
grouping the documents; and
creating a binder including the grouped documents.

8. The computer readable medium of claim 7, wherein the binder is portable.

9. The computer readable medium of claim 7 further comprising instructions for assigning access privileges to the documents.

10. The computer readable medium of claim 7 further comprising instructions for processing changes to the categories, wherein the changes include at least one of a following item from a group consisting of: altering the categories, adding other categories, and removing the categories.

11. The computer readable medium of claim 7 further comprising instructions for dynamically generating data entry fields based on at least one of a following action from a group consisting of: accessing the documents, changing data within the documents, accessing the binder, changing data within the binder, adding other documents, and adding other data.

12. A method for entering data relating to a document, comprising:
dynamically generating a layout of fields for data entry, based on a type of document chosen and on a specific template that is selected;
retrieving a pre-configured template containing a list of relevant fields, and directions for writing their contents to a database, wherein the relevant fields are related to the fields laid out for data entry; and
writing the contents of the relevant fields to the database.

13. The method of claim 12 further comprising adding fields to be dynamically generated in the layout.

14. The method of claim 13 further comprising receiving contents of the fields.

15. The method of claim 12 further comprising defaulting to contents related to the fields.

16. The method of claim 12 further comprising retrieving an action associated with a field of the relevant fields, wherein the action is defined in a first module.

17. The method of claim 16 further comprising, sending at least one of a following element from a second module to a third module from a list comprising:
the action;
an attribute type relating to the field;
an identification of the document; and
a content of the field to be entered.

18. The method of claim 17 further comprising supplying contents related to the action, by the first module to the third module.

19. The method of claim 18 further comprising receiving a message by the second module related to the supplied contents.

20. A system for document management, comprising:
means for generating a formatted list by consulting a template; and
means for displaying sets of metadata in the formatted list;
wherein the formatted list is adapted to display rows and columns of information.

21. The system of claim 20, wherein the template is consulted based on a context of a received request.

22. The system of claim 20, wherein the rows and columns of information are generated based on instructions in the template.

23. The system of claim 20, wherein the rows and columns of information can be sorted based on instructions in the template.

24. A system for document management, comprising:
a client adapted to generate a formatted list by consulting a template; and
a server adapted to display sets of metadata in the formatted list;
wherein the client is operably coupled to the server.
